(19) United States
(12) Patent Application Publication
(10) Pub. No.: US 2016/0292723 A1
(43) Pub. Date: Oct. 6, 2016

(54) VISUALIZATION OF ONLINE ADVERTISING REVENUE TRENDS

(71) Applicants: Haipeng Li, Mountain View, CA (US); Ying Liu, Palo Alto, CA (US); Allen Pang, San Jose, CA (US); Diana Luu, Toronto, CA (US)

(72) Inventors: Haipeng Li, Mountain View, CA (US); Ying Liu, Palo Alto, CA (US); Allen Pang, San Jose, CA (US); Diana Luu, Toronto, CA (US)

(21) Appl. No.: 14/724,594

(22) Filed: May 28, 2015

Related U.S. Application Data
(60) Provisional application No. 62/141,250, filed on Mar. 31, 2015.

(51) Int. Cl. G06Q 30/02

(52) U.S. Cl. CPC G06Q 30/0247; G06Q 30/0272

(57) ABSTRACT

A machine may be configured to facilitate visualization of online advertising revenue trends. For example, the machine accesses revenue booking data associated with a customer and identifying a revenue amount booked for delivering an ad product during a campaign delivery period of an advertising campaign associated with the customer. The machine determines a daily booking value for each date in the advertising campaign delivery period based on the revenue booking data and additional campaign data. The machine generates a revenue booking graph for the ad product based on the daily booking value for each date in the advertising campaign delivery period. The machine causes display of the revenue booking graph for the ad product in a user interface of a device.

### CLAIM OF PRIORITY

This application claims the benefit of priority, under 35 U.S.C. Section 119(e), U.S. Provisional Patent Application No. 62/141,250 (Attorney Docket No. 3080.C85PRV) by Haipeng Li et al., filed on Mar. 31, 2015, which is hereby incorporated herein by reference in its entirety.

### TECHNICAL FIELD

The present application relates generally to the processing of data, and, in various example embodiments, to systems, methods, and computer program products for visualization of online advertising revenue trends in a user interface of a device.

### BACKGROUND

Online advertising debuted as a new advertising medium in the mid-1990s to allow advertisers to promote their products and services on the Internet. Publishers (e.g., website owners) ran online ads on their web sites for the advertisers. The earliest ad serving software utilized by the publishers allowed the display of banner ads in the browsers of the users visiting the publishers' websites. In time, other types of online advertising have appeared, such as sponsored ads, affiliate ads, pay-per-click ads, etc.

As online advertising became more prevalent, certain methods for selling online advertising became more common. The Cost Per Thousand (also “CPM”) model was one of the earliest forms of selling online advertising and was based on an agreed rate for every one thousand impressions served. The Cost Per Click (also “CPC) model was often used and allowed publishers to charge advertisers a higher rate when users clicked on ads.

In addition to selling ad spots on their websites, the publishers are responsible to some degree for managing the advertising on their web sites. Generally, the publisher ensures that the online advertising campaign is set up properly and is receiving the online traffic promised to the advertiser. An online advertising campaign (also “advertising campaign” or “campaign”) may specify one or more types of advertising products (also “ad products”) to be delivered during a campaign delivery period and a collection of common settings that a creative or a group of creatives associated with an ad product should abide by. A creative is a form of advertising material, such as a banner, Hyper Text Markup Language (HTML) form, Flash file, etc. Common creative types include Graphics Interchange Format (GIF), Joint Photographic Experts Group (JPEG), Java, HTML, Flash, or streaming audio/video.

Generally, the publisher also provides reports regarding the advertising campaign to the advertiser. At the most basic level, reporting is used to determine overall campaign performance. An advertiser may want to know how many impressions and/or clicks a campaign received, and how it performed on specific parts of a site. Traditionally, if a report shows that a campaign under-delivered or had some other problem, a make-good agreement between the advertiser and the publisher may require that the publisher attempts to make it up to the advertiser (e.g., by setting up an additional campaign run to make up for what was not delivered at no extra cost to the advertiser, or giving the advertiser a credit or a refund).

### BRIEF DESCRIPTION OF THE DRAWINGS

Some embodiments are illustrated by way of example and not limitation in the figures of the accompanying drawings, in which:

FIG. 1 is a network diagram illustrating a client-server system, according to some example embodiments;

FIG. 2 is a block diagram illustrating components of a revenue monitoring system, according to some example embodiments;

FIG. 3 is a diagram illustrating a revenue-at-risk report presented in a user interface of a device, according to some example embodiments;

FIG. 4 is a diagram illustrating a revenue-at-risk report presented in a user interface of a device, according to some example embodiments;

FIG. 5 is a diagram illustrating example graphs generated by the revenue monitoring system, according to some example embodiments;

FIG. 6 is a flowchart illustrating a method for visualizing online advertising revenue trends, according to some example embodiments;

FIG. 7 is a flowchart illustrating a method for visualizing online advertising revenue trends, and representing an additional step of the method illustrated in FIG. 6, according to some example embodiments;

FIG. 8 is a flowchart illustrating a method for visualizing online advertising revenue trends, and representing additional steps of the method illustrated in FIG. 6, according to some example embodiments;

FIG. 9 is a flowchart illustrating a method for visualizing online advertising revenue trends, and representing steps 802, 804, and 806 of the method illustrated in FIG. 8 in more detail and an additional step of the method illustrated in FIG. 8, according to some example embodiments;

FIG. 10 is a flowchart illustrating a method for visualizing online advertising revenue trends, and representing steps 602, 606, and 608 of the method illustrated in FIG. 6 in more detail, according to some example embodiments;

FIG. 11 is a flowchart illustrating a method for visualizing online advertising revenue trends, and representing an additional step of the method illustrated in FIG. 6, according to some example embodiments;

FIG. 12 is a flowchart illustrating a method for visualizing online advertising revenue trends, and representing additional steps of the method illustrated in FIG. 6, according to some example embodiments;

FIG. 13 is a flowchart illustrating a method for visualizing online advertising revenue trends, and representing steps 1202, 1204, and 1206 of the method illustrated in FIG. 12 in more detail and an additional step of the method illustrated in FIG. 12, according to some example embodiments; and

FIG. 14 is a block diagram illustrating a mobile device, according to some example embodiments;

FIG. 15 is a block diagram illustrating components of a machine, according to some example embodiments, able to read instructions from a machine-readable medium and perform any one or more of the methodologies discussed herein.

### DETAILED DESCRIPTION

Example methods and systems for determining a revenue risk value representing a predicted revenue loss amount resulting from a predicted non-delivery of online advertising associated with a customer and for facilitating a minimization of the revenue risk value over a campaign delivery period are described. In the following description, for purposes of explanation, numerous specific details are set forth to provide a thorough understanding of example embodiments. It will be evident to one skilled in the art, however, that the present subject matter may be practiced without these specific details. Furthermore, unless explicitly stated otherwise, components and functions are optional and may be combined or subdivided, and operations may vary in sequence or be combined or subdivided.

Generally, in online advertising sales, sold advertising is delivered before revenue can be recognized. For example, a publisher and an advertising customer (also “customer” or “advertiser”) agree to the sale of 1,000 impressions at $1.00 per impression to be delivered between Jan. 1, 2015 and Jan. 31, 2015. The publisher may be required to deliver 1,000 impressions to users of the publisher's web site before the publisher earns $1,000.

One of the realities of online advertising is that problems may arise in the course of an online advertising campaign. For example, unforeseen circumstances may result in the campaign not delivering as many instances of an ad product (e.g., impressions) during the delivery period as was originally agreed upon. It is not uncommon for a delivered online ad revenue (e.g., the revenue that corresponds to the instances of an ad product that were served (or delivered) to viewers of the publisher's web site) to fall short of a booked revenue (e.g., the price agreed upon by the advertiser and publisher) for the campaign. It may be beneficial to the publisher to utilize a revenue monitoring system for determining a revenue risk value representing a predicted revenue loss amount resulting from a predicted non-delivery of online advertising associated with a customer and for facilitating a minimization of the revenue risk value over the campaign delivery period. Although capturing the entire booked revenue for a campaign may sometimes be challenging, the revenue monitoring system may assist the publisher in maximizing the delivery of the online advertising agreed upon with the customer and, therefore, maximizing the revenue delivered to the publisher.

Further, it may be beneficial to the publisher to utilize a tool for visualization of revenue and revenue risk trends. In some example embodiments, the visualization of revenue and revenue risk trends includes an act or a process of interpreting in visual terms or of putting into visible form revenue trends and revenue risk trends. The visualization of revenue and revenue risk trends may facilitate a better understanding of the various revenue-related and risk-related metrics, the minimization of the revenue risk value, and, ultimately, the maximization of the revenues delivered to the publisher.

In some example embodiments, the revenue monitoring system accesses a booked revenue value associated with a customer and representing a revenue amount booked for delivering online advertising associated with the customer during a delivery period. The revenue monitoring system also accesses a predicted revenue delivery value associated with the customer and representing a predicted revenue amount corresponding to online advertising that is associated with the customer and is forecast to be delivered within the delivery period. The revenue monitoring system also determines a revenue risk value associated with the customer based on the booked revenue value and the predicted revenue delivery value. The revenue risk value represents a predicted revenue loss amount resulting from a predicted non-delivery of online advertising associated with the customer. In some instances, the revenue risk value is the difference between the booked revenue value and the predicted revenue delivery value. The revenue monitoring system also causes presentation of the revenue risk value associated with the customer in a user interface of a device.

In some example embodiments, the revenue monitoring system also generates the predicted revenue delivery value associated with the customer. The predicted revenue delivery value associated with the customer may be based on one or more predicted revenue-per-product delivery values for one or more ad products to be delivered to users according to an advertising sales agreement between the publisher and the customer. In some instances, the users (e.g., the consumers of online advertising) are members of a social networking system. Specific members may be targeted to receive specific online advertising based on information about the members provided by the members to the social networking service (also “SNS”) or derived by the SNS based on member-provided data, such as membership profile data, social graph data, or member activity and behavior data.

In some instances, the revenue monitoring system identifies a particular ad product for delivering online advertising associated with the customer within the delivery period; selects a revenue-per-product prediction model corresponding to the particular ad product; and accesses historical ad delivery data for the particular ad product. The revenue monitoring system performs a revenue-per-product prediction modeling process based on the revenue-per-product prediction model and historical ad delivery data for the particular ad product, to generate a predicted revenue-per-product delivery value for the particular ad product. The predicted revenue-per-product value is associated with the customer. The historical ad delivery data may include a delivered revenue value for the one or more instances of the ad product actually delivered during an expired time of the delivery period to users targeted to receive online advertising associated with the customer.

The predicted revenue-per-product value may, in some instances, be comprised of the sum of an actually delivered revenue value determined based on the one or more instances of the ad product actually delivered to the users during an expired time of the delivery time, and a future revenue value generated based on the historical ad delivery data for the ad product and the actually delivered revenue value. In some example embodiments, the revenue monitoring system generates the predicted revenue delivery value associated with the customer based on a sum of a plurality of predicted revenue-per-product delivery values for a plurality of ad products to be delivered to users according to an advertising sales agreement between the publisher and the customer. In certain example embodiments, the revenue monitoring system generates the predicted revenue delivery value associated with the customer based on a sum of a plurality of predicted revenue-per-campaign delivery values for a plurality of online advertising campaigns to be delivered to users according to an advertising sales agreement between the publisher and the customer.

Consistent with certain example embodiments, different prediction models are used for the revenue-per-product prediction modeling processes pertaining to different ad products (e.g., Sponsored Updates, Display Ads, and Sponsored inMail). According to one example, the actually delivered revenue value corresponding to delivered Sponsored Updates pertaining to an online advertising campaign of a customer is generated based on the following ratio:

$$deliveryRatio = \frac{last 28 DayDeliveredRev}{last 28 DayBookedRev} ,$$

where “last28DayDeliveredRev” is the revenue value corresponding to the Sponsored Updates delivered to users within 28 days prior to the refresh date and “last28DayBookedRev” is the booked revenue value corresponding to the Sponsored Updates booked within 28 days prior to the refresh date. The refresh date is the last date when delivered revenue was computed. In some instances, the computing of the delivered revenue value is performed daily.

The expected daily delivery value corresponding to the predicted daily revenue to deliver all Sponsored Updates pertaining to the campaign (and all booked revenue) on time is generated based on the following ratio:

$$expectedDailyDeliveredRev = \frac{bookedRevLeft}{daysLeft} ,$$

where “bookedRevLeft” is the portion of booked revenue that is yet to be delivered, and where “daysLeft” is the number of days left in the delivery period (also “flight”) of the online advertising campaign.

For a Sponsored Updates campaign that has started and has delivery history during the last seven days, the following formula may be used to determine a projected revenue value on a particular future day, n:

Projected Rev on Day n=last7dAvg×delivery Ratio,

where “last7dAvg” is a value corresponding to the average revenue delivered in the last seven days.

For a Sponsored Updates campaign that has started but has no delivery history in the last seven days, the following formula may be used to determine a projected revenue value on a particular future day, n:

Projected Revenue on Day n=expectedDailyDeliveredRev×deliveryRatio.

For a Sponsored Updates campaign that has not started yet, the following formula may be used to determine a projected revenue value on a particular future day, n:

Projected Rev on Day n=dailyBookedRev×deliveryRatio.

In some example embodiments, the projection is weighted by a factor of 0.7 (or another weight value or factor) if day n is a Saturday or a Sunday. The future revenue value corresponding to a future (e.g., non-expired) time segment of the campaign delivery period may be generated based on a projected revenue value on day n and the number of days in the future time segment of the campaign delivery period.

According to another example, different Display Ad campaigns employ different pricing models, such as Cost Per Day (CPD), Cost per Thousand Impressions (CPM), or Cost Per Click (CPC). For a CPD campaign:

Projected Rev on day n=0,

if day n is beyond the flight of the campaign; or

Projected Rev on day n=dailyBooking,

if day n is within the flight of the campaign, where “dailyBooking” is a revenue value corresponding to the Booked Revenue value divided by the number of days in the flight.

For a CPM or a CPC campaign:

Projected Rev on day n=0,

if day n is beyond the flight of the campaign;

Projected Rev on day n=last7dAvg,

if there is revenue delivered in the last seven days; or

Projected Rev on day n=dailyBooking,

if no revenue is delivered within the last seven days.
In some example embodiments, the projection is weighted by a factor of 0.5 (or another weight value or factor) if day n is a Saturday or a Sunday.

According to yet another example, in the case of Sponsored InMail, the reason for a delay in delivery of InMail factors in forecasting InMail revenue. For an InMail campaign, the projected revenue on day n may be generated based on the following formula:

Projected Revenue on day n=BookedRevenue×reasonWeight,

if day n is the last day within the contracted date range.
It may be assumed that any future InMail will be delivered on the last day of the contracted time period.

Projected Revenue on day n=0,

otherwise.

Table 1 below illustrates example non-delivery reasons for InMail and associated example weights. Similar reasons may exist for the delay or non-delivery of other ad products, such as Display Ads or Sponsored Updates.

TABLE 1
Example reasons for non-delivery of InMail
and example corresponding weights.

| inMail Risk | | |
|---|---|---|
| Classification | Description | Weight |
| Cancelled | Cancelled line item/deal | 0% |
| Pushed/reallocation | Revenue pushed into a future quarter | 0% |
| | or moved to a different product | |
| Red lit - Late creative | No creative/partial creative | 25% |
| Red lit - Contract | Contract held up with CBA/Legal/ | 50% |
| awaiting internal | Revenue | |
| Red lit - Contract | Contract waiting on client approval | 50% |
| awaiting external | | |
| Internal system issues/ | inMail dashboard, member-finder | 50% |
| capabilities | issues | |
| inMail built - Pending | Waiting on internal creative | 75% |
| internal approval | approval | |
| inMail built - Pending | Waiting on client to approve inMail | 75% |
| external approval | mock | |
| No Risk - Will drop on | 100% sure inMail will drop on time | 90% |
| time | | |

The revenue monitoring system may facilitate the identifying of one or more reasons why certain ad products are not being delivered to users of the publisher's web site. The revenue monitoring system may also facilitate the collaborating among a group of people managing an account associated with the advertiser to prioritize time and effort in order to address the identified reasons for non-delivery and to maximize the delivery of the sold advertising during the delivery period. As a result, the publisher may save on any make-good cost associated with an agreement between the advertiser and the publisher that may require the publisher to set up an additional campaign to make up for what was not delivered at no extra cost to the advertiser, or to give the advertiser a credit or a refund.

In addition, because the revenue monitoring system is scalable, it may facilitate the monitoring of a large number of online advertising campaigns. In some example embodiments, the monitoring of the campaigns includes ranking of a plurality of campaigns based on various factors (e.g., the revenue risk value associated with each of the campaigns), generating of various reports pertaining to the campaigns, as well as generating of action reminders for the teams managing particular campaigns.

Accordingly, in one example embodiment, this disclosure provides a system that comprises a memory for storing instructions and a hardware processor, which, when executing instructions, causes the system to access a booked revenue value associated with a customer and representing a revenue amount booked for delivering online advertising associated with the customer during a delivery period. The hardware processor also causes the system to access a predicted revenue delivery value associated with the customer and representing a predicted revenue amount corresponding to online advertising that is associated with the customer and is forecast to be delivered within the delivery period. The hardware processor also causes the system to determine a revenue risk value associated with the customer based on the booked revenue value and the predicted revenue delivery value. The revenue risk value represents a predicted revenue loss amount resulting from a predicted non-delivery of online advertising associated with the customer. Finally, the hardware processor causes the system to cause presentation of the revenue risk value associated with the customer in a user interface of a device.

In another embodiment of the system, the hardware processor further causes the system to identify a particular ad product for delivering online advertising associated with the customer within the delivery period. The hardware processor also causes the system to select a revenue-per-product prediction model corresponding to the particular ad product. The hardware processor also causes the system to access historical ad delivery data for the particular ad product. Finally, the hardware processor causes the system to perform a revenue-per-product prediction modeling process to generate a predicted revenue-per-product delivery value for the particular ad product. The performing of the revenue-per-product prediction modeling process may be based on the revenue-per-product prediction model and historical ad delivery data for the particular ad product. The predicted revenue-per-product value may be associated with the customer.

In a further embodiment of the system, the booked revenue value is associated with an online advertising campaign for delivering the online advertising associated with the customer during the delivery period. The online advertising campaign comprises one or more ad products including the particular ad product. The predicted revenue delivery value represents one or more predicted revenue-per-product values for the one or more ad products comprised in the online advertising campaign including the predicted revenue-per-product value for the particular ad product.

In yet another embodiment of the system, the predicted revenue-per-product value is based on a sum of a first revenue value corresponding to one or more actually delivered instances of the ad product and a second revenue value corresponding to one or more instances of the ad product likely to be delivered during the delivery period.

In yet a further embodiment of the system, the historical ad delivery data includes a delivered revenue value for the one or more instances of the ad product actually delivered during an expired time of the delivery period to users targeted to receive online advertising associated with the customer.

In another embodiment of the system, the performing of the ad delivery prediction modeling process comprises: determining an actually delivered revenue value based on the one or more instances of the ad product actually delivered to the users during an expired time of the delivery time; generating a future revenue value based on the historical ad delivery data for the ad product and the actually delivered revenue value; accessing a reason indicator that indicates a reason for a delay in a delivery of one or more instances of the ad product to be delivered; and assigning a weight to the future revenue value based on the reason indicator, the assigning of the weight resulting in a weighted future revenue value, wherein the generating of the predicted revenue-per-product value for the ad product is based on the weighted future revenue value.

In a further embodiment of the system, the hardware processor further causes the system to determine a risk-per-reason value associated with the customer. The risk-per-reason value represents a revenue risk amount corresponding to the reason for the delay in the delivery of the one or more instances of the ad product. The hardware processor also causes the system to generate a report that includes one or more risk-per-reason values associated with the customer, wherein the causing of presentation of the revenue risk value associated with the customer includes causing presentation of the one or more risk-per-reason values associated with the customer in the user interface of the device.

In yet another embodiment of the system, the hardware processor further causes the system to identify an action associated with the reason indicator that indicates the reason for the delay in the delivery of the one or more instances of the ad product. The hardware processor also causes the system to generate an action reminder for an account administrator. Finally, the hardware processor also causes the system to transmit a communication including the action reminder to the device. The device may be associated with the account administrator.

This disclosure also provides a method that comprises accessing a booked revenue value associated with a customer and representing a revenue amount booked for delivering online advertising associated with the customer during a delivery period. The method also comprises accessing a predicted revenue delivery value associated with the customer and representing a predicted revenue amount corresponding to online advertising that is associated with the customer and is forecast to be delivered within the delivery period. The method further comprises determining, using one or more hardware processors, a revenue risk value associated with the customer based on the booked revenue value and the predicted revenue delivery value. The revenue risk value represents a predicted revenue loss amount resulting from a predicted non-delivery of online advertising associated with the customer. Finally, the method comprises causing presentation of the revenue risk value associated with the customer in a user interface of a device.

In a further embodiment of the method, the method further comprises identifying a particular ad product for delivering online advertising associated with the customer within the delivery period. The method also comprises selecting a revenue-per-product prediction model corresponding to the particular ad product. The method further comprises accessing historical ad delivery data for the particular ad product. Finally, the method comprises performing a revenue-per-product prediction modeling process based on the revenue-per-product prediction model and historical ad delivery data for the particular ad product, to generate a predicted revenue-per-product delivery value for the particular ad product, the predicted revenue-per-product value being associated with the customer.

In yet another embodiment of the method, the booked revenue value is associated with an online advertising campaign for delivering the online advertising associated with the customer during the delivery period. The online advertising campaign comprises one or more ad products including the particular ad product. The predicted revenue delivery value represents one or more predicted revenue-per-product values for the one or more ad products comprised in the online advertising campaign including the predicted revenue-per-product value for the particular ad product.

In yet a further embodiment of the method, the predicted revenue-per-product value is based on a sum of a first revenue value corresponding to one or more actually delivered instances of the ad product and a second revenue value corresponding to one or more instances of the ad product likely to be delivered during the delivery period.

In another embodiment of the method, the historical ad delivery data includes a delivered revenue value for the one or more instances of the ad product actually delivered during an expired time of the delivery period to users targeted to receive online advertising associated with the customer.

In a further embodiment of the method, the performing of the revenue-per-product prediction modeling process comprises: determining an actually delivered revenue value based on the one or more instances of the ad product actually delivered to the users during an expired time of the delivery time; generating a future revenue value based on the historical ad delivery data for the ad product and the actually delivered revenue value; accessing a reason indicator that indicates a reason for a delay in a delivery of one or more instances of the ad product to be delivered; and assigning a weight to the future revenue value based on the reason indicator, the assigning of the weight resulting in a weighted future revenue value, wherein the generating of the predicted revenue-per-product value for the ad product is based on the weighted future revenue value.

In yet another embodiment of the method, the method further comprises determining a risk-per-reason value associated with the customer. The risk-per-reason value represents a revenue risk amount corresponding to the reason for the delay in the delivery of the one or more instances of the ad product. The method also comprises generating a report that includes one or more risk-per-reason values associated with the customer, wherein the causing of presentation of the revenue risk value associated with the customer includes causing presentation of the one or more risk-per-reason values associated with the customer in the user interface of the device.

In yet a further embodiment of the method, the method further comprises identifying an action associated with the reason indicator that indicates the reason for the delay in the delivery of the one or more instances of the ad product. The method also comprises generating an action reminder for an account administrator. Finally, the method comprises transmitting a communication including the action reminder to the device, the device being associated with the account administrator.

In another embodiment of the method, the one or more instances of the ad product include impressions targeting a member of a social networking system based on one or more member attributes associated with the member.

In a further embodiment of the method, the revenue risk value is further associated with a particular online advertising campaign. The method further comprises ranking a plurality of online advertising campaigns including the particular online advertising campaign based on the revenue risk value associated with each of the plurality of online advertising campaigns, wherein the causing of the presentation of the revenue risk value includes displaying, in the user interface of the device, a list of identifiers of the plurality of online advertising campaigns ranked based on the revenue risk value associated with each of the plurality of online advertising campaigns.

In yet another embodiment of the method, the online advertising associated with the customer includes one or more ad products associated with a particular online advertising campaign for the customer. The determining of the revenue risk value associated with the customer includes generating a product revenue risk value for a particular ad product of the one or more ad products based on a booked revenue value corresponding to the particular ad product and a predicted revenue delivery value corresponding to the particular ad product. The product revenue risk value represents a predicted revenue loss amount resulting from a predicted non-delivery of one or more instances of the particular ad product to the one or more users. The causing of the presentation of the revenue risk value includes displaying one or more product revenue risk values for the one or more ad products associated with the particular online advertising campaign including the product revenue risk value for the particular ad product.

This disclosure also provides a non-transitory machine-readable storage medium comprising instructions that, when executed by one or more processors of a machine, cause the machine to perform operations comprising accessing a booked revenue value associated with a customer and representing a revenue amount booked for delivering online advertising associated with the customer during a delivery period. The operations also comprise accessing a predicted revenue delivery value associated with the customer and representing a predicted revenue amount corresponding to online advertising that is associated with the customer and is forecast to be delivered within the delivery period. The operations further comprise determining a revenue risk value associated with the customer based on the booked revenue value and the predicted revenue delivery value, the revenue risk value representing a predicted revenue loss amount resulting from a predicted non-delivery of online advertising associated with the customer. Finally, the operations comprise causing presentation of the revenue risk value associated with the customer in a user interface of a device.

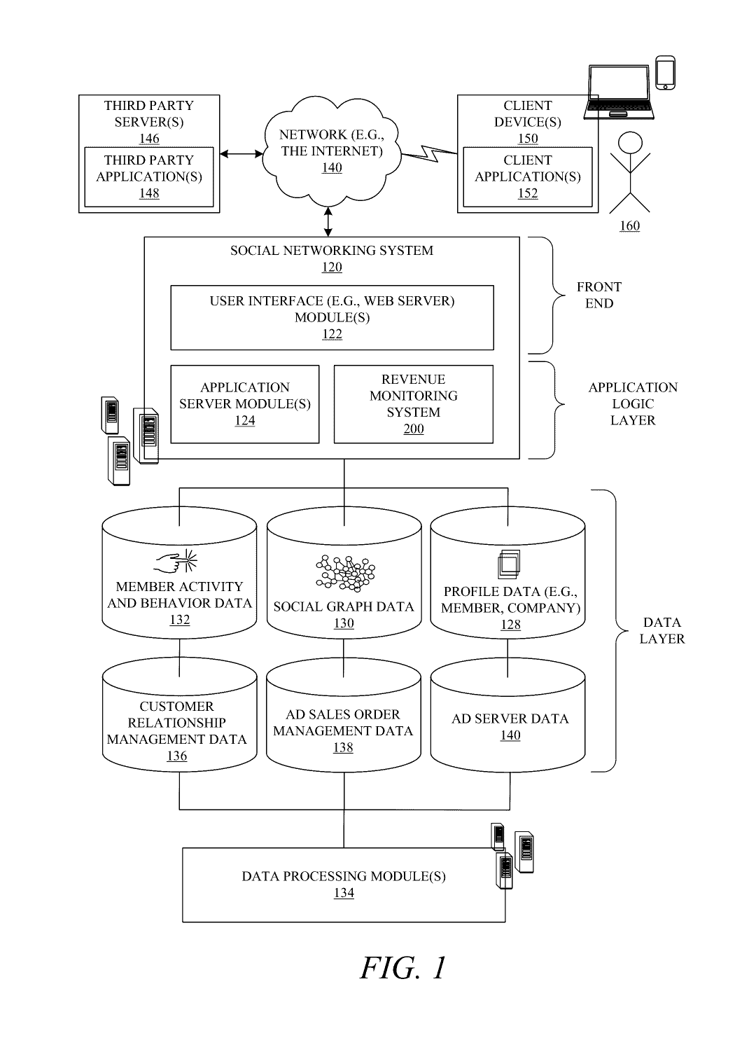

An example method and system for visualization of online advertising revenue trends may be implemented in the context of the client-server system illustrated in FIG. 1. As illustrated in FIG. 1, the revenue monitoring system 200 is part of the social networking system 120. As shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social networking system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front end layer consists of a user interface module(s) (e.g., a web server) 122, which receives requests from various client-computing devices including one or more client device(s) 150, and communicates appropriate responses to the requesting device. For example, the user interface module(s) 122 may receive requests in the form of Hypertext Transport Protocol (HTTP) requests, or other web-based, application programming interface (API) requests. The client device(s) 150 may be executing conventional web browser applications and/or applications (also referred to as “apps”) that have been developed for a specific platform to include any of a wide variety of mobile computing devices and mobile-specific operating systems (e.g., iOS™, Android™, Windows® Phone).

For example, client device(s) 150 may be executing client application(s) 152. The client application(s) 152 may provide functionality to present information to the user and communicate via the network 140 to exchange information with the social networking system 120. Each of the client devices 150 may comprise a computing device that includes at least a display and communication capabilities with the network 140 to access the social networking system 120. The client devices 150 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, smart watches, tablets, ultrabooks, netbooks, laptops, desktops, multi-processor systems, microprocessor-based or programmable consumer electronics, game consoles, set-top boxes, network PCs, mini-computers, and the like. One or more users 160 may be a person, a machine, or other means of interacting with the client device(s) 150. The user(s) 160 may interact with the social networking system 120 via the client device(s) 150. The user(s) 160 may not be part of the networked environment, but may be associated with client device(s) 150.

As shown in FIG. 1, the data layer includes several databases, including a database 128 for storing data for various entities of a social graph. In some example embodiments, a “social graph” is a mechanism used by an online social networking service (e.g., provided by the social networking system 120) for defining and memorializing, in a digital format, relationships between different entities (e.g., people, employers, educational institutions, organizations, groups, etc.). Frequently, a social graph is a digital representation of real-world relationships. Social graphs may be digital representations of online communities to which a user belongs, often including the members of such communities (e.g., a family, a group of friends, alums of a university, employees of a company, members of a professional association, etc.). The data for various entities of the social graph may include member profiles, company profiles, educational institution profiles, as well as information concerning various online or offline groups. Of course, with various alternative embodiments, any number of other entities may be included in the social graph, and as such, various other databases may be used to store data corresponding to other entities.

Consistent with some embodiments, when a person initially registers to become a member of the social networking service, the person is prompted to provide some personal information, such as the person's name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database 128.

Once registered, a member may invite other members, or be invited by other members, to connect via the social networking service. A “connection” may specify a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available content items for presentation to the member in his or her content stream increases. As members interact with various applications, content, and user interfaces of the social networking system 120, information relating to the member's activity and behavior may be stored in a database, such as the database 132.

The social networking system 120 may provide a broad range of other applications and services that allow members the opportunity to share and receive information, often customized to the interests of the member. For example, with some embodiments, the social networking system 120 may include a photo sharing application that allows members to upload and share photos with other members. With some embodiments, members of the social networking system 120 may be able to self-organize into groups, or interest groups, organized around a subject matter or topic of interest. With some embodiments, members may subscribe to or join groups affiliated with one or more companies. For instance, with some embodiments, members of the social networking service may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with social graph data of the database 130. In some example embodiments, members may receive advertising targeted to them based on various factors (e.g., member profile data, social graph data, member activity or behavior data, etc.)

The application logic layer includes various application server module(s) 124, which, in conjunction with the user interface module(s) 122, generates various user interfaces with data retrieved from various data sources or data services in the data layer. With some embodiments, individual application server modules 124 are used to implement the functionality associated with various applications, services, and features of the social networking system 120. For instance, a messaging application, such as an email application, an instant messaging application, or some hybrid or variation of the two, may be implemented with one or more application server modules 124. A photo sharing application may be implemented with one or more application server modules 124. Similarly, a search engine enabling users to search for and browse member profiles may be implemented with one or more application server modules 124.

In some example embodiments, a data aggregating engine for aggregating data pertaining to advertising revenues and risks may be implemented with one or more application server modules 124. For example, the data aggregating engine may select and aggregate data associated with a sale of online advertising to a customer (e.g., an advertiser) and/or delivery of online advertising to targeted users, such as an online ad sales order, a booked revenue value associated with the customer, a description of an advertising campaign, product identifiers of ad product included in the advertising campaign, identifiers of targeted users, or the number of instances of delivered ad products. In some instances, this and other types of data pertaining to sales and deliveries of online advertising may be stored in the customer relationship management (CRM) database 136, ad sales order management database 138, ad server database 140, or another database. The aggregated data may be used by a revenue monitoring system 200 to predict a likely revenue delivery value associated, for example, with a customer, advertising campaign, or ad product, and to determine a revenue value at risk of non-delivery to the targeted users and the reasons for the non-delivery among other things. The aggregated data may also be used by the revenue monitoring system 200 to facilitate the visualization of online advertising revenue trends. For example, the revenue monitoring system 200 may, based on data pertaining to advertising revenues and risks, generate revenue-related graphs to illustrate revenue trends or revenue risk trends associated with an advertising product or with an advertising campaign that includes one or more advertising products. Of course, other applications and services may be separately embodied in their own application server modules 124. As illustrated in FIG. 1, social networking system 120 may include the revenue monitoring system 200, which is described in more detail below.

Further, as shown in FIG. 1, a data processing module 134 may be used with a variety of applications, services, and features of the social networking system 120. The data processing module 134 may periodically access one or more of the databases 128, 130, 132, 136, 138, or 140, process (e.g., execute batch process jobs to analyze or mine) profile data, social graph data, member activity and behavior data, CRM data ad sales order management data, or ad server data, and generate analysis results based on the analysis of the respective data. The data processing module 134 may operate offline. According to some example embodiments, the data processing module 134 operates as part of the social networking system 120. Consistent with other example embodiments, the data processing module 134 operates in a separate system external to the social networking system 120. In some example embodiments, the data processing module 134 may include multiple servers, such as Hadoop servers for processing large data sets. The data processing module 134 may process data in real time, according to a schedule, automatically, or on demand.

Additionally, a third party application(s) 148, executing on a third party server(s) 146, is shown as being communicatively coupled to the social networking system 120 and the client device(s) 150. The third party server(s) 146 may support one or more features or functions on a website hosted by the third party.

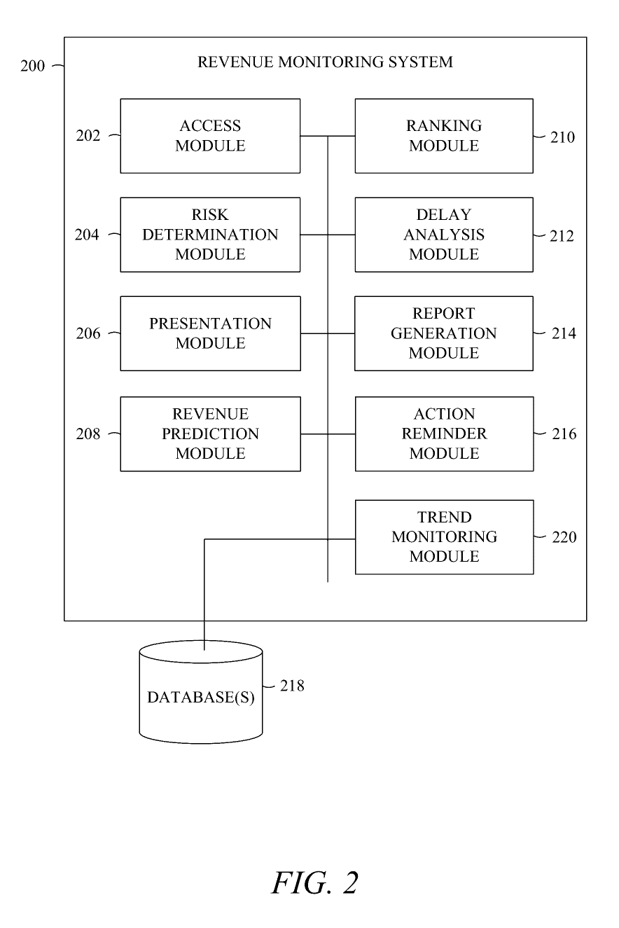

FIG. 2 is a block diagram illustrating components of the revenue monitoring system 200, according to some example embodiments. As shown in FIG. 2, the revenue monitoring system 200 includes an access module 202, a risk determination module 204, a presentation module 206, a revenue prediction module 208, a ranking module 210, a delay analysis module 212, a report generation module 214, an action reminder module 216, and a trend monitoring module 220, all configured to communicate with each other (e.g., via a bus, shared memory, or a switch).

According to some example embodiments, the access module 202 accesses (e.g., receives) a booked revenue value associated with a customer (e.g., and advertiser). The booked revenue value represents a revenue amount booked for delivering online advertising associated with the customer during a delivery period.

The access module 202 also accesses (e.g., receives) a predicted revenue delivery value associated with the customer. The predicted revenue delivery value represents a predicted revenue amount corresponding to online advertising that is associated with the customer and is forecast to be delivered within the delivery period.

In some example embodiments, the access module 202 facilitates the monitoring and visualization of revenue trends and revenue risk trends pertaining to delivery of online advertising products. In one example embodiment, the access module 202 accesses revenue booking data associated with a customer and identifying a revenue amount booked for delivering an ad product during a campaign delivery period of an advertising campaign associated with the customer. In another example embodiment, the access module 202 accesses a daily delivered revenue value for each past date of the advertising campaign delivery period, the daily delivered revenue value corresponding to one or more instances of the ad product delivered as part of the advertising campaign. In a further example embodiment, the access module 202 accesses a plurality of daily delivered revenue values each associated with a plurality of ad products included in the advertising campaign, the plurality of daily delivered revenue values including the daily delivered revenue value. In yet another example embodiment, the access module 202 accesses a revenue booking value corresponding to an amount booked for delivering a plurality of ad products during a campaign delivery period. The plurality of ad products is included in the advertising campaign. In yet a further example embodiment, the access module 202 accesses a forecast daily revenue value for each future date of the advertising campaign delivery period, the forecast daily revenue value corresponding to one or more instances of the ad product forecast to be delivered at a future date as part of the advertising campaign. In another example embodiment, the access module 202 accesses a plurality of forecast daily revenue values each associated with a plurality of ad products included in the advertising campaign.

The risk determination module 204 determines a revenue risk value associated with the customer based on the booked revenue value and the predicted revenue delivery value, as described above. The revenue risk value represents a predicted revenue loss amount resulting from a predicted non-delivery of online advertising associated with the customer. In some instances, the revenue risk value is the difference between the booked revenue value and the predicted revenue delivery value.

The presentation module 206 causes presentation of the revenue risk value associated with the customer in a user interface of a device. The presentation module 206 may also cause presentation of rankings, reports, action reminder, among other things, pertaining to revenue and revenue-at-risk associated with one or more online advertising campaigns. The presentation module 206 may also cause display of a revenue-related graph (e.g., a revenue booking graph, a delivered revenue graph, a forecast revenue graph, etc.) in the user interface of the device.

The revenue prediction module 208 performs a revenue-per-product prediction modeling process to generate a predicted revenue-per-product value for a particular ad product, as described above. The revenue prediction module 208 may also perform a revenue-per-campaign prediction modeling process to generate a predicted revenue-per-campaign value for a particular advertising campaign that includes one or more products.

In some example embodiments, the revenue prediction module 208 performs a revenue-per-product prediction modeling process based on the revenue-per-product prediction model and historical ad delivery data for the particular ad product, to generate a predicted revenue-per-product delivery value for the particular ad product. The historical ad delivery data may include a delivered revenue value for the one or more instances of the ad product actually delivered during an expired time of the delivery period to users targeted to receive online advertising associated with the customer. The predicted revenue-per-product value may, in some instances, be comprised of the sum of an actually delivered revenue value determined based on the one or more instances of the ad product actually delivered to the users during an expired time of the delivery time, and a future revenue value generated based on the historical ad delivery data for the ad product and the actually delivered revenue value.

In some example embodiments, the revenue prediction module 208 generates a predicted revenue delivery value associated with the customer based on a sum of a plurality of predicted revenue-per-product delivery values for a plurality of ad products to be delivered to users according to an advertising sales agreement between the publisher and the customer. In certain example embodiments, the revenue prediction module 208 generates the predicted revenue delivery value associated with the customer based on a sum of a plurality of predicted revenue-per-campaign delivery values for a plurality of online advertising campaigns to be delivered to users according to an advertising sales agreement between the publisher and the customer.

The ranking module 210 ranks a plurality of online advertising campaigns based on the revenue risk value associated with each of the plurality of online advertising campaigns.

The delay analysis module 212 identifies a reason for a delay in a delivery of one or more instances of an ad product to be delivered and determines a risk-per-reason value. The risk-per-reason value represents a revenue risk amount corresponding to the reason for the delay in the delivery of the one or more instances of the ad product.

In some example embodiments, the one or more instances of the ad product include impressions targeting a member of a social networking system based on one or more member attributes associated with the member. In certain example embodiments, the one or more instances of the ad product include electronic communications (e.g., email messages, InMails, etc.) targeting a member of a social networking system based on one or more member attributes associated with the member.

The report generation module 214 may generate a report that includes the predicted revenue delivery value associated with the customer. The report generation module 214 may also generate a report that includes the revenue risk value associated with the customer.

The action reminder module 216 identifies an action associated with the reason indicator that indicates the reason for the delay in the delivery of the one or more instances of the ad product. The action reminder module 216 also generates an action reminder for an account administrator. The account administrator may be a user of the device who is associated with or manages the campaign, or is authorized to view information pertaining to the revenue and revenue-at-risk of the campaign, such as an Account Executive, a Campaign Manager, a Vice-President of Sales, a Chief Executive Officer, etc. The action reminder module 216 also transmits a communication including the action reminder to the device. The device may be associated with an account administrator.

The trend monitoring module 220 facilitates the monitoring and visualization of revenue trends and revenue risk trends pertaining to delivery of online advertising products. In one example embodiment, the trend monitoring module 220 determines a daily booking value for each date in the advertising campaign delivery period based on the revenue booking data and additional campaign data (e.g., a number of days in the advertising campaign delivery period, whether the start of the advertising campaign delivery period occurred on the planned date, etc.). The trend monitoring module 220 also generates a revenue booking graph for the ad product based on the daily booking value for each date in the advertising campaign delivery period.

In another example embodiment, the trend monitoring module 220 generates a daily delivered revenue value for each past date of the advertising campaign delivery period based on the revenue booking data and historical ad delivery data. The daily delivered revenue value corresponds to one or more instances of the ad product delivered to one or more users as part of the advertising campaign.

In a further example embodiment, the trend monitoring module 220 generates a delivered revenue graph for the ad product based on the daily delivered revenue value for each past date of the advertising campaign delivery period. The trend monitoring module 220 also causes display of the delivered revenue graph for the ad product in the user interface of the device.

In yet another example embodiment, the trend monitoring module 220 aggregates the plurality of daily delivered revenue values upon the access module 202 accesses a plurality of daily delivered revenue values each associated with a plurality of ad products included in the advertising campaign, the plurality of daily delivered revenue values including the daily delivered revenue value. The trend monitoring module 220 also generates a delivered revenue graph for the advertising campaign including the plurality of ad products. The trend monitoring module 220 further causes display of the delivered revenue graph for the advertising campaign in the user interface of the device.

In yet a further example embodiment, the trend monitoring module 220 generates a revenue booking graph for the advertising campaign including the plurality of ad products based on the revenue booking value corresponding to the amount booked for delivering the plurality of ad products during the campaign delivery period. The trend monitoring module 220 also causes display of the revenue booking graph for the advertising campaign in the user interface of the device.

In another example embodiment, the trend monitoring module 220 generates a forecast daily revenue value for each future date of the advertising campaign delivery period based on a revenue prediction model and historical ad delivery data. The forecast daily revenue value identifies a predicted revenue value for each future date of the advertising campaign delivery period. The forecast daily revenue value corresponds to one or more instances of the ad product forecast to be delivered at a future date as part of the advertising campaign.

In a further example embodiment, the trend monitoring module 220 generates a forecast revenue graph for the ad product based on the forecast daily revenue value for each future date of the advertising campaign delivery period. The trend monitoring module 220 also causes display of the forecast revenue graph for the ad product in the user interface of the device.

In yet another example embodiment, the trend monitoring module 220 aggregates the plurality of forecast daily revenue values upon the access module 202 accessing a plurality of forecast daily revenue values each associated with a plurality of ad products included in the advertising campaign. The trend monitoring module 220 also generates a forecast revenue graph for the advertising campaign including the plurality of ad products. The trend monitoring module 220 further causes display of the forecast revenue graph for the advertising campaign in the user interface of the device.

To perform one or more of its functionalities, the revenue monitoring system 200 may communicate with one or more other systems. An integration engine may integrate the revenue monitoring system 200 with one or more email server(s), web server(s), one or more databases, or other servers, systems, or repositories. A measurement and reporting engine may determine the performance of one or more modules of the revenue monitoring system 200. An optimization engine may optimize one or more of the models associated with one or more modules of the revenue monitoring system 200.

Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. In some example embodiments, any one or more of the modules described herein may comprise one or more hardware processors and may be configured to perform the operations described herein. In certain example embodiments, one or more hardware processors are configured to include any one or more of the modules described herein.

Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources, so as to allow information to be passed between the applications so as to allow the applications to share and access common data. Furthermore, the modules may access one or more databases 218 (e.g., database 128, 130, 132, 136, 138, or 140).

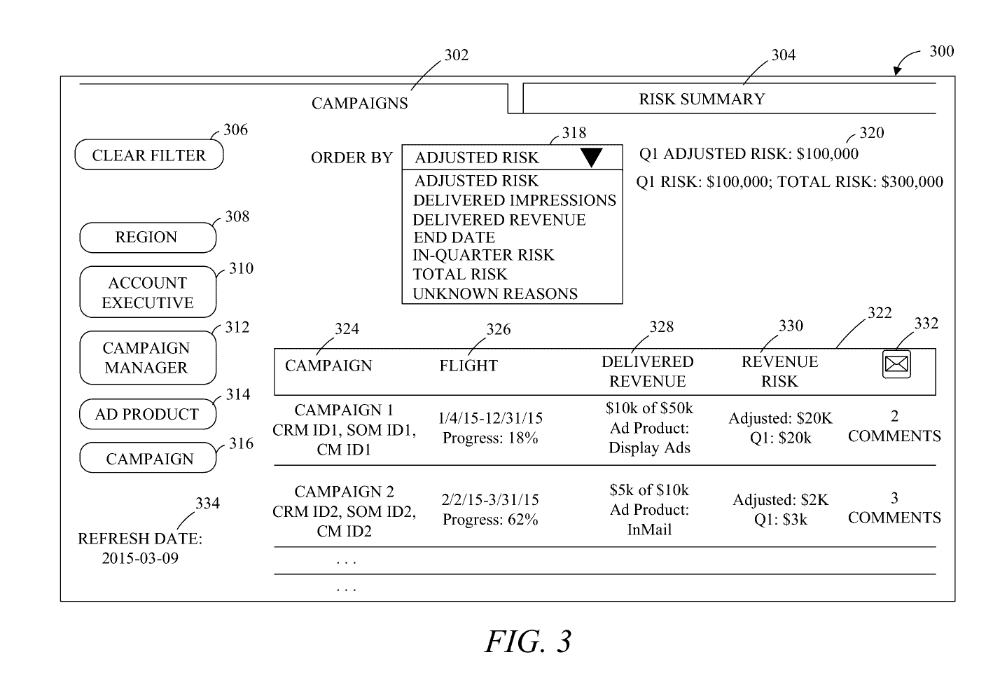

FIG. 3 is a diagram 300 illustrating a revenue-at-risk report presented in a user interface of a device, according to some example embodiments. The revenue risk value associated with a customer may be determined based on a booked revenue value associated with the customer and a predicted revenue delivery value associated with the customer. The revenue risk value represents a predicted revenue loss amount resulting from a predicted non-delivery of online advertising associated with the customer. The revenue risk value associated with the customer may be based on the revenue risk values associated with one or more advertising campaigns associated with the customer. In turn, the revenue risk values associated with a particular advertising campaign associated with the customer may be based on the revenue risk values associated with one or more ad products included in the particular advertising campaign associated with the customer. In some instances, a particular advertising campaign corresponds to a particular type of ad product (e.g., Sponsored Updates, InMail, or Displayed Ads). As discussed above, the revenue monitoring system 200 may cause the presentation of a revenue risk value associated with the customer in a user interface of a device. The device may be associated with an account administrator.

In some example embodiments, as shown in FIG. 3, the user interface may present a revenue-at-risk report in a tabbed view including two tabs: the campaigns tab 302 and the risk summary tab 304. In FIG. 3, the campaigns tab 302 is the primary (or active) tab and the risk summary tab 304 is the secondary (or inactive) tab. An account administrator may navigate between the campaigns tab 302 and the risk summary tab 304 by clicking on the headers of the respective tab.

The user interface of FIG. 3 may include a presentation 322 of information pertaining to one or more advertising campaigns that may be ordered based on a variety of factors selectable (e.g., by the account administrator) from a drop-down menu 318, such as adjusted risk, delivered impressions, delivered revenue, end date, in-quarter risk, total risk, unknown reasons for the delay in delivery of the advertising, etc. The presentation 322 may include, for each displayed identifier of an advertising campaign, information pertaining to the advertising campaign such as one or more identifiers (e.g., a name of the campaign, an account ID associated with the campaign, a sales order number, a campaign manager ID, etc.) of the campaign 324, a flight range (e.g., a campaign delivery period) 326, a delivered revenue value 328, a revenue risk value 330, and a comment identifier 332. For example, as shown in FIG. 3, the presentation 322 includes an identifier of a first campaign (e.g., Campaign 1) that is associated with a plurality of other identifiers (e.g., Customer Relationship Management (CRM) ID1, Sales Order management (SOM) ID1, Campaign Manager (CM) ID1, etc.), a date range (e.g., Jan. 4, 2015-Dec. 31, 2015) reflecting the period during which Campaign 1 is scheduled to run, a percentage value (e.g., 18%) representing the progress of Campaign 1, a delivered revenue value (e.g., $10,000 or $10 k), a booked revenue value (e.g., $50,000 or $50 k), a type of Ad Product (e.g., Display Ads), an adjusted revenue risk value (e.g., $20,000 or $20 k), a Q1 revenue risk value (e.g., $20,000 or $20 k), and an indicator that two comments are associated with a status report and/or reason for a delay in delivering one or more instances of the advertising included in Campaign 1, as shown in Table 2 below. The adjusted revenue risk value is the calculated risk value further adjusted by the input of a user (e.g., a campaign manager). For example, for a campaign line item the calculated risk value is $20 k based on the formula. However, if the user has indicated there is actually no risk then the final risk number will be adjusted to $0 according to the user input.

TABLE 2
Example Comments Window to display the comments
associated with an online advertising campaign.

Comments for CRM Order 1234:

John Williams, 2015-02-04, 09:00;10
“Ads have launched for all Display lines. Waiting on Assets for Feb
InMail.”
John Williams, 2015-01-30, 12:30:00
“Mocks sent to the client. Waiting on Display Assets (300, 160, text).
Waiting on Assets for Feb InMail.”

Similarly, the presentation 322 includes an identifier of a second campaign (e.g., Campaign 2) that is associated with a plurality of identifiers (e.g., CRM ID2, SOM ID2, CM ID2, etc.), a date range (e.g., Feb. 2, 2015-Mar. 31, 2015) reflecting the period during which Campaign 2 is scheduled to run, a percentage value (e.g., 62%) representing the progress of Campaign 2, a delivered revenue value (e.g., $5,000 or $5 k), a booked revenue value (e.g., $10,000 or $10 k), a type of Ad Product (e.g., InMail), an adjusted revenue risk value (e.g., $2,000 or $2 k), a Q1 revenue risk value (e.g., $3,000 or $3 k), and an indicator that three comments are associated with a status report and/or reason for a delay in delivering one or more instances of the advertising included in Campaign 2.

The user interface of FIG. 3 may also include one or more buttons (e.g., a region button 308, an account executive button 310, a campaign manager button 312, an ad product button 314, and a campaign button 316) for filtering the data presented in the presentation 322. For example, the selection of the region button 308 allows the account administrator to select a region (e.g., a region in the world or a designated sales region) from a plurality of regions to limit the data presented to the selected region. The selection of the account executive button 310 may allow the account administrator to request the filtering of the data presented based on an identifier (e.g., a name) of the account executive associated with one or more advertising campaigns. The selection of the campaign manager button 312 may allow the account administrator to request the filtering of the presented data based on an identifier (e.g., a name) of the campaign manager associated with one or more advertising campaigns. The selection of the ad product button 314 may allow the account administrator to request the filtering of the presented data based on an identifier (e.g., a name, a number, etc.) of an ad product (e.g., Sponsored Updates, Display Ads, or InMail Ads). Similarly, the selection of the campaign button 310 may allow the account administrator to request the filtering of the presented data based on an identifier (e.g., a name) of an advertising campaign. Additionally, the user interface may include a clear filter button 306 to clear the selected filter(s).

The user interface may also include a Refresh Date value 346 that indicates the date when the predicted revenue delivery value and the revenue risk value associated with the campaigns were last generated (e.g., computed). In some examples, the computations are performed daily.

Also, the user interface displays one or more aggregated risk values 320 that are based on all the advertising online campaigns run by the publisher. As shown in FIG. 3, the one or more risk values 320 include an adjusted revenue risk value associated with a particular quarter (e.g., Q1). The one or more risk values 320 also includes a risk value associated with a particular quarter (e.g., $100,000) that represents the revenue that is at risk of not being delivered by the publisher during the particular quarter (e.g., Q1) of the year. The one or more risk values 320 also include a total risk value (e.g., $300,000) that represents the revenue that is at risk of not being delivered by the publisher during the year.

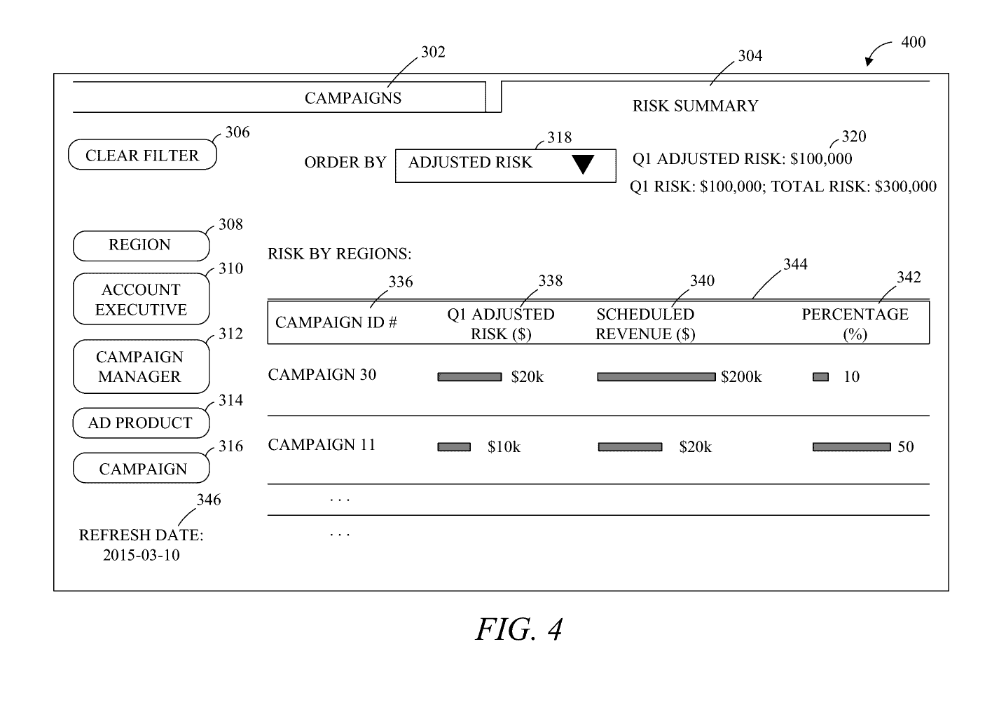

FIG. 4 is a diagram 400 illustrating a revenue-at-risk report presented in a user interface of a device, according to some example embodiments. As shown in FIG. 4, the risk summary tab 304 is the primary (or active) tab and the campaigns tab 302 is the secondary (or inactive) tab. An account administrator may navigate between the campaigns tab 302 and the risk summary tab 304 by clicking on the headers of the respective tab.

The user interface of FIG. 4 may include a presentation 344 of risk values associated with one or more online advertising campaigns. The campaign identifiers and the associated risk and revenue information displayed in the presentation 344 may be filtered based on a variety of factors, such as a region selected from a list of regions 308, an account executive selected from a list of account executives 310, a campaign manager selected from a list of campaign managers 312, an ad product selected from a list of ad products 314, or a campaign selected from a list of campaigns 316. Also, the campaign identifiers and the associated risk and revenue information displayed in the presentation 344 may be ordered using the drop-down menu 318, as discussed above.

The presentation 344 may include, for each displayed advertising campaign, risk and revenue information pertaining to the advertising campaign, such as a campaign ID number 336, an adjusted risk value 338 associated with a particular quarter (e.g., Q1), a scheduled revenue value 340, and a percentage value that represents the percentage of the adjusted risk value 338 as compared to the scheduled revenue value 340. For example, as shown in FIG. 4, the presentation 344 includes risk and revenue information for Campaign 30, such as an identifier (e.g., a name) of Campaign 30, a Q1 adjusted risk value (e.g., $20,000 or $20 k), a scheduled revenue value ($200,000 or $200 k), and a percentage value (e.g., 10%). Similarly, the presentation 344 includes risk and revenue information for a further campaign, Campaign 11, such as an identifier (e.g., a name) of Campaign 11, a Q1 adjusted risk value (e.g., $10,000 or $10 k), a scheduled revenue value ($20,000 or $20 k), and a percentage value (e.g., 50%). The user interface of FIG. 4 also displays the refresh date 346 (e.g., 2015 Mar. 10) and one or more aggregated risk values 320, as discussed above.

In some example embodiments, the user interface of FIG. 4 includes a display of risk information by ad product, and may include information such as an adjusted risk value associated with a particular ad product for a particular quarter, a booked revenue associated with the particular ad product, and a percentage value representing the share of the adjusted risk value as compared to the booked revenue. In some example embodiments, the user interface of FIG. 4 includes a display of reasons for delay in delivering online advertising together with risk values, revenue values, and percentage values corresponding to particular reasons for delivery delays.

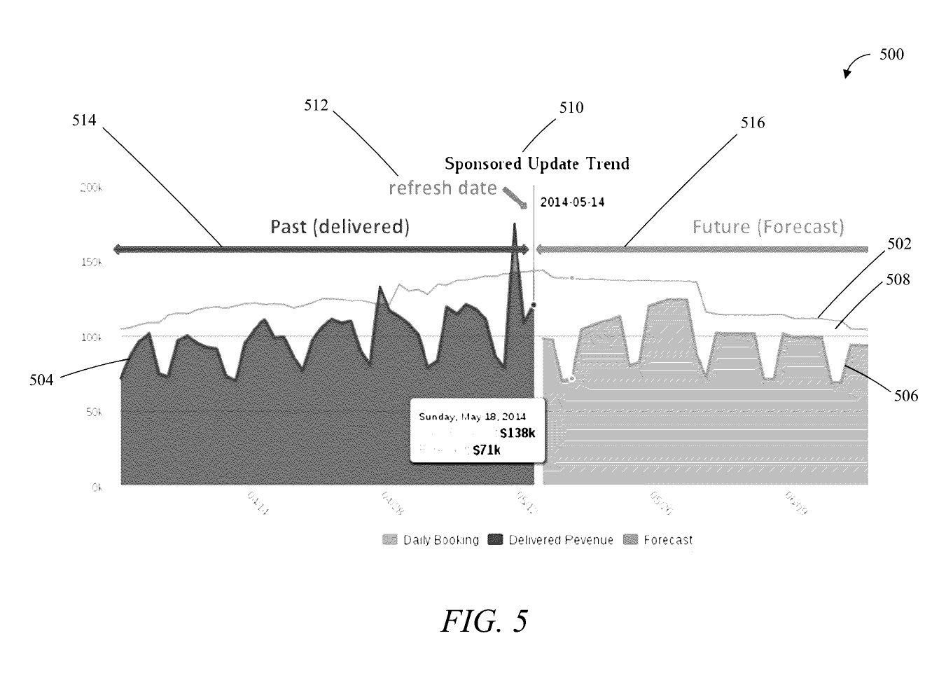

FIG. 5 is a diagram illustrating example graphs generated by the revenue monitoring system, according to some example embodiments. According to some example embodiments, the revenue monitoring system 200 facilitates the visualization of revenue trends and revenue risk trends pertaining to delivery of online advertising products. The revenue monitoring system 200 may analyze revenue and revenue risk data pertaining to the delivery of one or more ad products and may generate one or more graphs that illustrate one or more revenue-related trends (e.g., a delivered revenue trend associated with an ad product, a forecast revenue trend associated with an ad product, a revenue risk associated with an ad product, a delivered revenue trend associated with an advertising campaign, a forecast revenue trend associated with an ad campaign, a revenue risk associated with an ad campaign, etc.). The revenue monitoring system 200 may also cause display of the one or more graphs in a user interface of a device (e.g., a device associated with an administrator). The causing of the display of the one or more graphs may facilitate a user's (e.g., an administrator's) understanding of the one or more revenue-related trends. Moreover, the causing of the display of the one or more graphs may allow the user to observe the emergence of a new revenue-related trend. By observing a problematic revenue-related trend, the user may address an underlying problem in a more timely fashion and, therefore, may assist the publisher in maximizing the delivery of the online advertising to consumers of online advertising and maximizing the revenue delivered to the publisher.

As shown in FIG. 5, in some example embodiments, the revenue monitoring system 200 causes the display of a plurality of revenue-related graphs (e.g., graphs 502, 504, and 506). Graph 502 represents a revenue booking graph for an ad product 510 (e.g., Sponsored Update). The revenue monitoring system 200 generates graph 502 based on the daily booking value for each date in the advertising campaign delivery period associated with an advertising campaign for the customer.

The advertising campaign delivery period includes a past (e.g., expired) period of time 514, a refresh date (e.g., a present date during which various computations described herein are performed) 512, and a future period of time 516 remaining in the advertising campaign delivery period after the refresh date 512. In some examples, the computations are performed daily.

Graph 504 represents a delivered revenue graph for the ad product 510. The revenue monitoring system 200 generates graph 504 based on the daily delivered revenue value for each past date of the advertising campaign delivery period (e.g., each past date of the past period of time 514). The daily delivered revenue value corresponds to one or more instances of the ad product delivered to one or more users as part of the advertising campaign.

Graph 506 represents a forecast revenue graph for the ad product 510. The revenue monitoring system 200 generates graph 506 based on the forecast daily revenue value for each future date of the advertising campaign delivery period. The forecast daily revenue value identifies a predicted revenue value for each future date of the advertising campaign delivery period. The forecast daily revenue value corresponds to one or more instances of the ad product forecast to be delivered at a future date as part of the advertising campaign.

As illustrated in FIG. 5, area 508 (e.g., the area below graph 502 and above graph 504 and graph 506) represents the risk of non-delivery of revenue associated with one or more instances of the ad product 510 not delivered during the advertising campaign. The risk of non-delivery may be a predicted revenue loss amount resulting from a predicted non-delivery of instances of an online ad product.

In some example embodiments, the revenue monitoring system 200 generates graphs that illustrate one or more revenue-related trends pertaining to an advertising campaign for the customer. The revenue monitoring system 200 may generate a revenue booking graph for the advertising campaign including a plurality of ad products based on the revenue booking value corresponding to the amount booked for delivering the plurality of ad products during the campaign delivery period. The revenue monitoring system 200 may cause display of the revenue booking graph for the advertising campaign in the user interface of the device.

In certain example embodiments, the revenue monitoring system 200 also accesses a plurality of daily delivered revenue values each associated with a plurality of ad products included in the advertising campaign and may aggregate the plurality of daily delivered revenue values. The aggregating may result in an aggregated daily delivered revenue value. The revenue monitoring system 200 may further generate a delivered revenue graph for the advertising campaign including the plurality of ad products based on the aggregated daily delivered revenue value. The revenue monitoring system 200 may then cause display of the delivered revenue graph for the advertising campaign in the user interface of the device.

In various example embodiments, the revenue monitoring system 200 also accesses a plurality of forecast daily revenue values each associated with a plurality of ad products included in the advertising campaign and may aggregate the plurality of forecast daily revenue values. The aggregating may result in an aggregated forecast daily revenue value. The revenue monitoring system 200 may further generate a forecast revenue graph for the advertising campaign including the plurality of ad products based on the aggregated forecast daily revenue value. The revenue monitoring system 200 may then cause display of the forecast revenue graph for the advertising campaign in the user interface of the device.

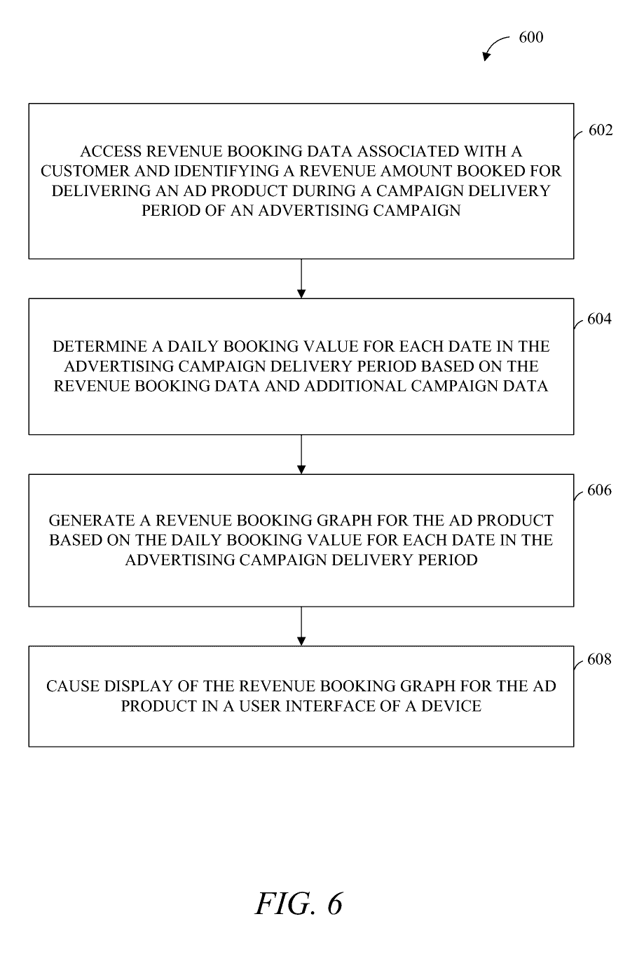

FIGS. 6-13 are flowcharts illustrating a method for visualization of online advertising revenue trends, according to some example embodiments. Operations in the method 600 illustrated in FIG. 6 may be performed using modules described above with respect to FIG. 2. As shown in FIG. 6, method 600 may include one or more of method operations 602, 604, 606, and 608, according to some example embodiments.

At method operation 602, the access module 202 accesses revenue booking data associated with a customer and identifying a revenue amount booked for delivering an ad product during a campaign delivery period of an advertising campaign associated with the customer.

At method operation 604, the trend monitoring module 220 determines a daily booking value for each date in the advertising campaign delivery period based on the revenue booking data and additional campaign data.

At method operation 606, the trend monitoring module 220 generates a revenue booking graph for the ad product based on the daily booking value for each date in the advertising campaign delivery period.

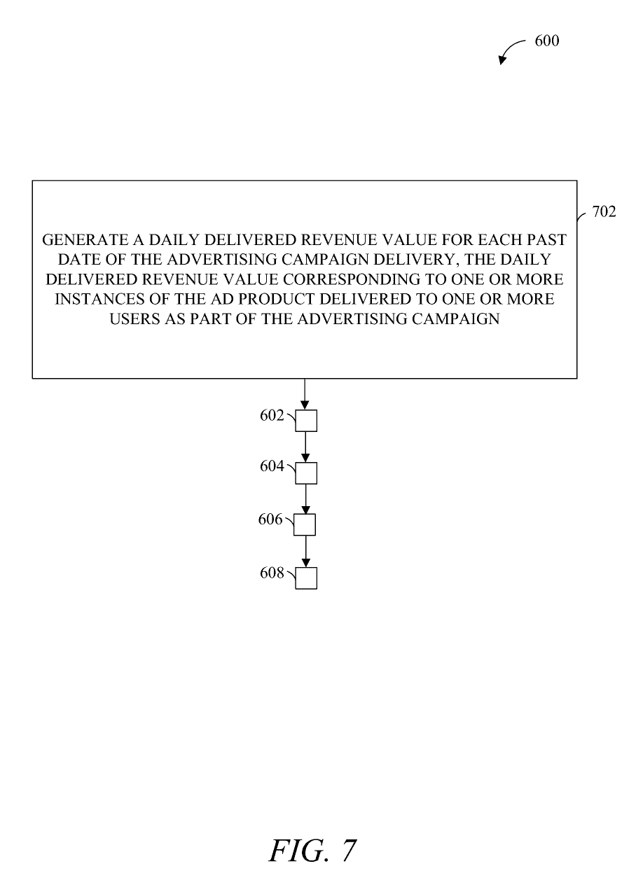

At method operation 608, the presentation module 206 causes display of the revenue booking graph for the ad product in a user interface of a device. Further details with respect to the method operations of the method 600 are described below with respect to FIGS. 7-13.

As shown in FIG. 7, the method 600 may include method operation 702, according to some example embodiments. Method operation 702 may be performed before method operation 602, in which the access module 202 accesses revenue booking data associated with a customer and identifying a revenue amount booked for delivering an ad product during a campaign delivery period of an advertising campaign associated with the customer.

At method operation 702, the trend monitoring module 220 generates a daily delivered revenue value for each past date of the advertising campaign delivery period based on the revenue booking data and historical ad delivery data. The daily delivered revenue value corresponds to one or more instances of the ad product delivered to one or more users as part of the advertising campaign. The historical ad delivery data may include a delivered revenue value for one or more instances of the ad product included in the advertising campaign that were actually delivered during an expired time of the delivery period.

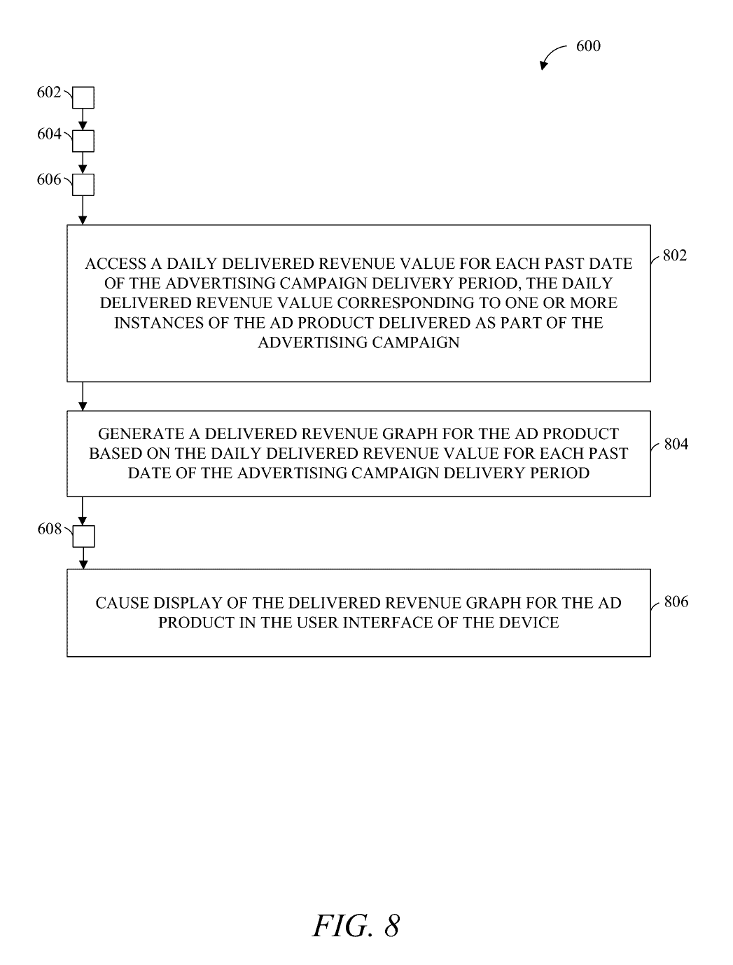

As shown in FIG. 8, the method 600 may include one or more of operations 802, 804, and 806, according to some example embodiments. Method operation 802 may be performed after method operation 606, in which the trend monitoring module 220 generates a revenue booking graph for the ad product based on the daily booking value for each date in the advertising campaign delivery period.

At method operation 802, the access module 202 accesses a daily delivered revenue value for each past date of the advertising campaign delivery period. The daily delivered revenue value corresponds to one or more instances of the ad product delivered as part of the advertising campaign.

Method operation 804 is performed after method operation 802. At method operation 804, the trend monitoring module 220 generates a delivered revenue graph for the ad product based on the daily delivered revenue value for each past date of the advertising campaign delivery period.

Method operation 806 may be performed after method operation 608, in which the presentation module 206 causes display of the revenue booking graph for the ad product in a user interface of a device. At method operation 806, the presentation module 206 causes display of the delivered revenue graph for the ad product in the user interface of the device.

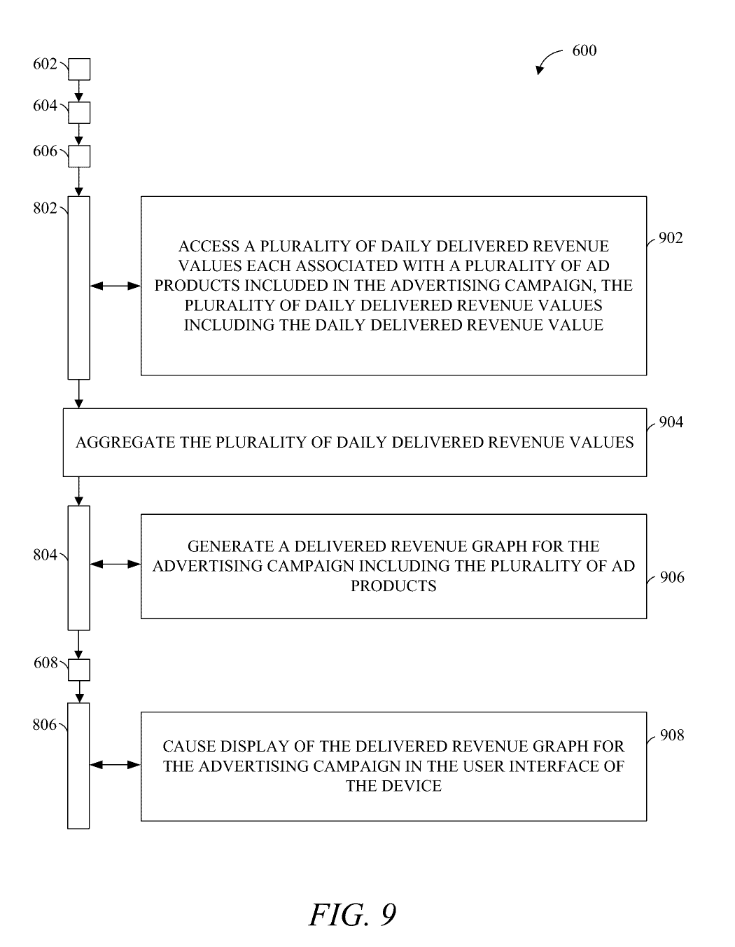

As shown in FIG. 9, the method 600 may include one or more of method operations 902, 904, 906, and 908, according to some example embodiments. Method operation 902 may be performed as part (e.g., a precursor task, a subroutine, or a portion) of method operation 802, in which the access module 202 accesses a daily delivered revenue value for each past date of the advertising campaign delivery period.

At method operation 902, the access module 202 accesses a plurality of daily delivered revenue values each associated with a plurality of ad products included in the advertising campaign. The plurality of daily delivered revenue values includes the daily delivered revenue value.

Method operation 904 is performed after method operation 802. At method operation 904, the trend monitoring module 220 aggregates the plurality of daily delivered revenue values. The aggregating results in an aggregated daily delivered revenue value.

Method operation 906 may be performed as part (e.g., a precursor task, a subroutine, or a portion) of method operation 804, in which the trend monitoring module 220 generates a delivered revenue graph for the ad product based on the daily delivered revenue value for each past date of the advertising campaign delivery period. At method operation 906, the trend monitoring module 220 generates a delivered revenue graph for the advertising campaign including the plurality of ad products based on the aggregated daily delivered revenue value.

Method operation 908 may be performed as part (e.g., a precursor task, a subroutine, or a portion) of method operation 806, in which the presentation module 206 causes display of the delivered revenue graph for the ad product in the user interface of the device. At method operation 908, the presentation module 206 causes display of the delivered revenue graph for the advertising campaign in the user interface of the device.

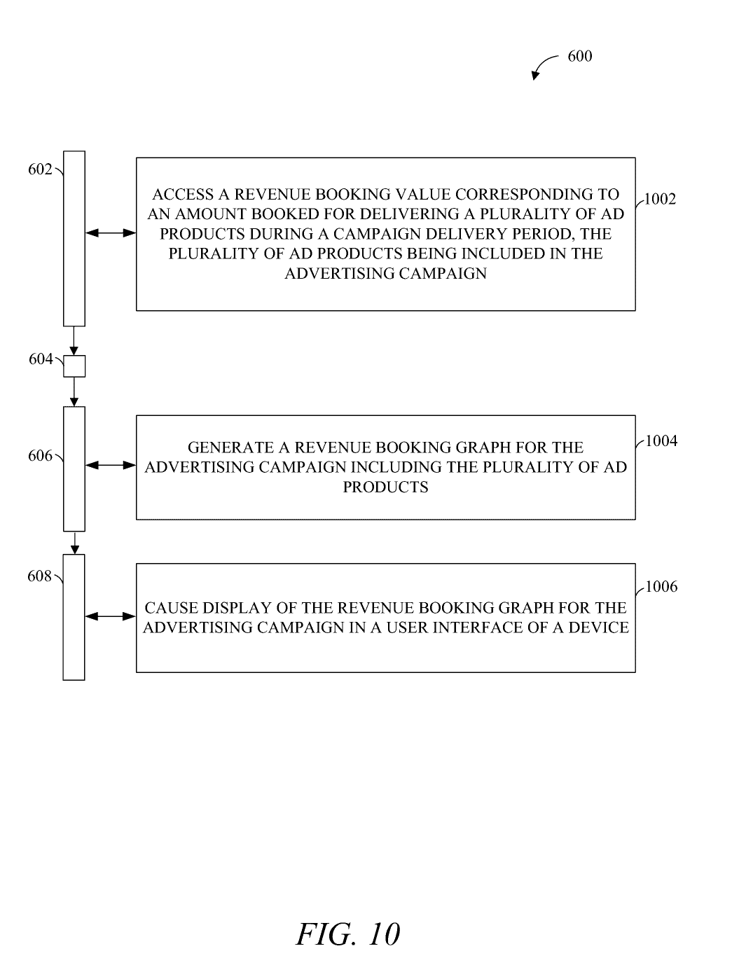

As shown in FIG. 10, the method 600 may include method operations 1002, 1004, and 1006, according to some example embodiments. Method operation 1002 may be performed as part (e.g., a precursor task, a subroutine, or a portion) of method operation 602, in which the access module 202 accesses revenue booking data associated with a customer and identifying a revenue amount booked for delivering an ad product during a campaign delivery period of an advertising campaign associated with the customer.

At method operation 1002, the access module 202 accesses a revenue booking value corresponding to an amount booked for delivering a plurality of ad products during a campaign delivery period. The plurality of ad products is included in the advertising campaign.

Method operation 1004 may be performed as part (e.g., a precursor task, a subroutine, or a portion) of method operation 606, in which the trend monitoring module 220 generates a revenue booking graph for the ad product based on the daily booking value for each date in the advertising campaign delivery period. At method operation 1004, the trend monitoring module 220 generates a revenue booking graph for the advertising campaign including the plurality of ad products based on the revenue booking value corresponding to the amount booked for delivering the plurality of ad products during the campaign delivery period.

Method operation 1006 may be performed as part (e.g., a precursor task, a subroutine, or a portion) of method operation 608, in which the presentation module 206 causes display of the revenue booking graph for the ad product in a user interface of a device. At method operation 1006, the presentation module 206 causes display of the revenue booking graph for the advertising campaign in the user interface of the device.

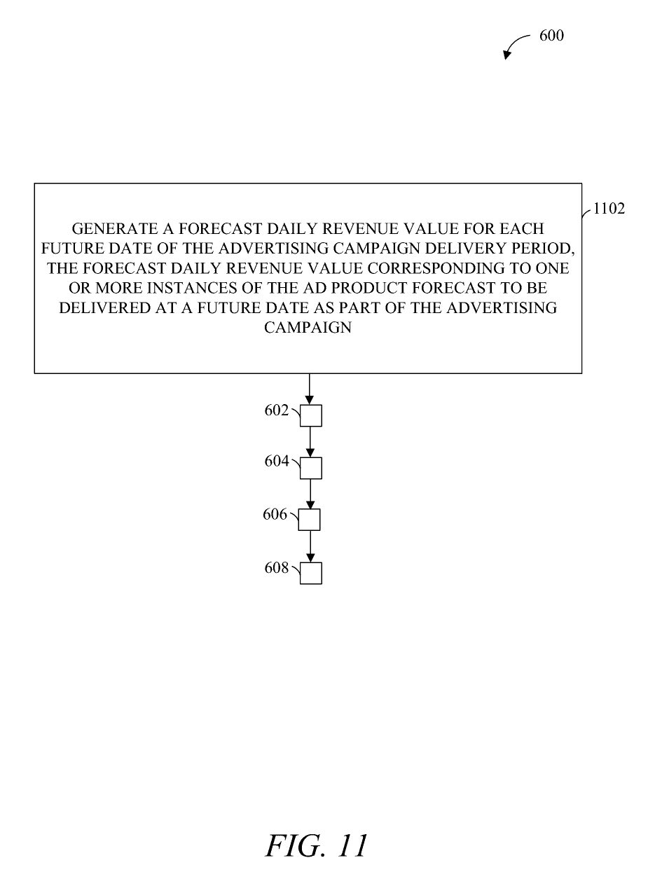

As shown in FIG. 11, the method 600 may include a method operation 1102, according to some example embodiments. Method operation 1102 may be performed before method operation 602, in which the access module 202 accesses revenue booking data associated with a customer and identifying a revenue amount booked for delivering an ad product during a campaign delivery period of an advertising campaign associated with the customer.

At method operation 1102, the trend monitoring module 220 generates a forecast daily revenue value for each future date of the advertising campaign delivery period based on a revenue prediction model and historical ad delivery data. The forecast daily revenue value identifies a predicted revenue value for each future date of the advertising campaign delivery period. The forecast daily revenue value corresponds to one or more instances of the ad product forecast to be delivered at a future date as part of the advertising campaign.

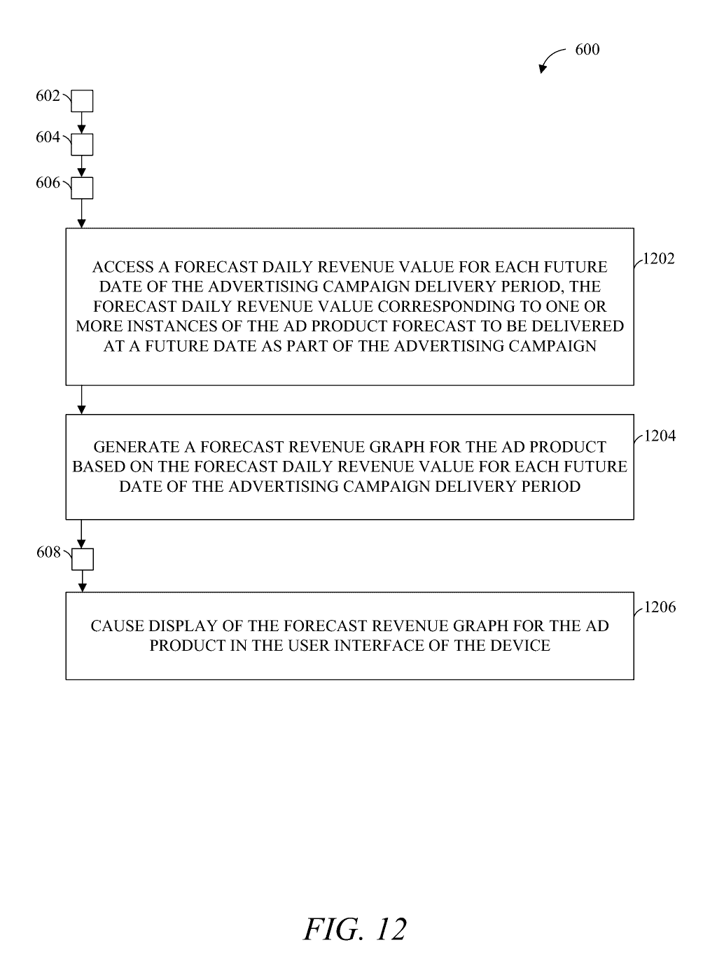

As shown in FIG. 12, the method 600 may include method operations 1202, 1204, and 1206, according to some example embodiments. Method operation 1202 may be performed after method operation 606, in which the trend monitoring module 220 generates a revenue booking graph for the ad product based on the daily booking value for each date in the advertising campaign delivery period.

At method operation 1202, the access module 202 accesses a forecast daily revenue value for each future date of the advertising campaign delivery period. The forecast daily revenue value corresponds to one or more instances of the ad product forecast to be delivered at a future date as part of the advertising campaign.

Method operation 1204 is performed after method operation 1202. At method operation 1204, the trend monitoring module 220 generates a forecast revenue graph for the ad product based on the forecast daily revenue value for each future date of the advertising campaign delivery period.

Method operation 1206 may be performed after method operation 608, in which the presentation module 206 causes display of the revenue booking graph for the ad product in a user interface of a device. At method operation 1206, the presentation module 206 causes display of the forecast revenue graph for the ad product in the user interface of the device.

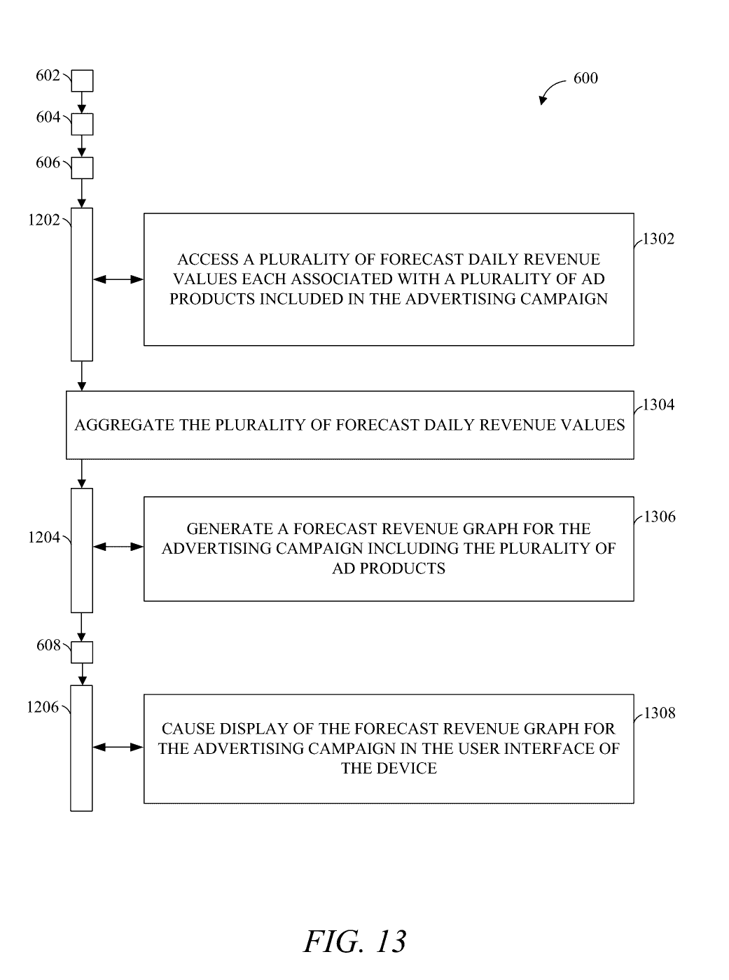

As shown in FIG. 13, the method 600 may include method operations 1302, 1304, 1306, and 1308, according to some example embodiments. Method operation 1302 may be performed as part (e.g., a precursor task, a subroutine, or a portion) of method operation 1202, in which the access module 202 accesses a forecast daily revenue value for each future date of the advertising campaign delivery period. At method operation 1302, the access module 202 accesses a plurality of forecast daily revenue values each associated with a plurality of ad products included in the advertising campaign.

Method operation 1304 may be performed after method operation 1202. At method operation 1304, the trend monitoring module 220 aggregates the plurality of forecast daily revenue values. The aggregating results in an aggregated forecast daily revenue value.

Method operation 1306 may be performed as part (e.g., a precursor task, a subroutine, or a portion) of method operation 1204, in which the trend monitoring module 220 generates a forecast revenue graph for the ad product based on the forecast daily revenue value for each future date of the advertising campaign delivery period. At method operation 1306, the trend monitoring module 220 generates a forecast revenue graph for the advertising campaign including the plurality of ad products based on the aggregated forecast daily revenue value.

Method operation 1308 may be performed as part (e.g., a precursor task, a subroutine, or a portion) of method operation 1206, in which the presentation module 206 causes display of the forecast revenue graph for the ad product in the user interface of the device. At method operation 1308, the presentation module 206 causes display of the forecast revenue graph for the advertising campaign in the user interface of the device.

### Example Mobile Device

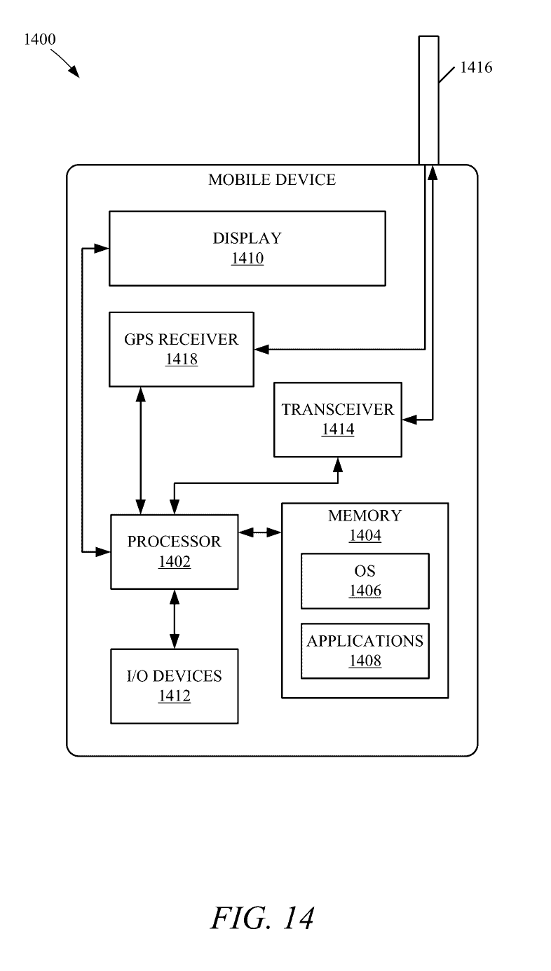

FIG. 14 is a block diagram illustrating a mobile device 1400, according to an example embodiment. The mobile device 1400 may include a processor 1402. The processor 1402 may be any of a variety of different types of commercially available processors 1402 suitable for mobile devices 1400 (for example, an XScale architecture microprocessor, a microprocessor without interlocked pipeline stages (MIPS) architecture processor, or another type of processor 1402). A memory 1404, such as a random access memory (RAM), a flash memory, or other type of memory, is typically accessible to the processor 1402. The memory 1404 may be adapted to store an operating system (OS) 1406, as well as application programs 1408, such as a mobile location enabled application that may provide LBSs to a user. The processor 1402 may be coupled, either directly or via appropriate intermediary hardware, to a display 1410 and to one or more input/output (I/O) devices 1412, such as a keypad, a touch panel sensor, a microphone, and the like. Similarly, in some embodiments, the processor 1402 may be coupled to a transceiver 1414 that interfaces with an antenna 1416. The transceiver 1414 may be configured to both transmit and receive cellular network signals, wireless data signals, or other types of signals via the antenna 1416, depending on the nature of the mobile device 1400. Further, in some configurations, a GPS receiver 1418 may also make use of the antenna 1416 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors or processor-implemented modules, not only residing within a single machine, but deployed across a number of machines. In some example embodiments, the one or more processors or processor-implemented modules may be located in a single location (e.g., within a home environment, an office environment or as a server farm), while in other embodiments the one or more processors or processor-implemented modules may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

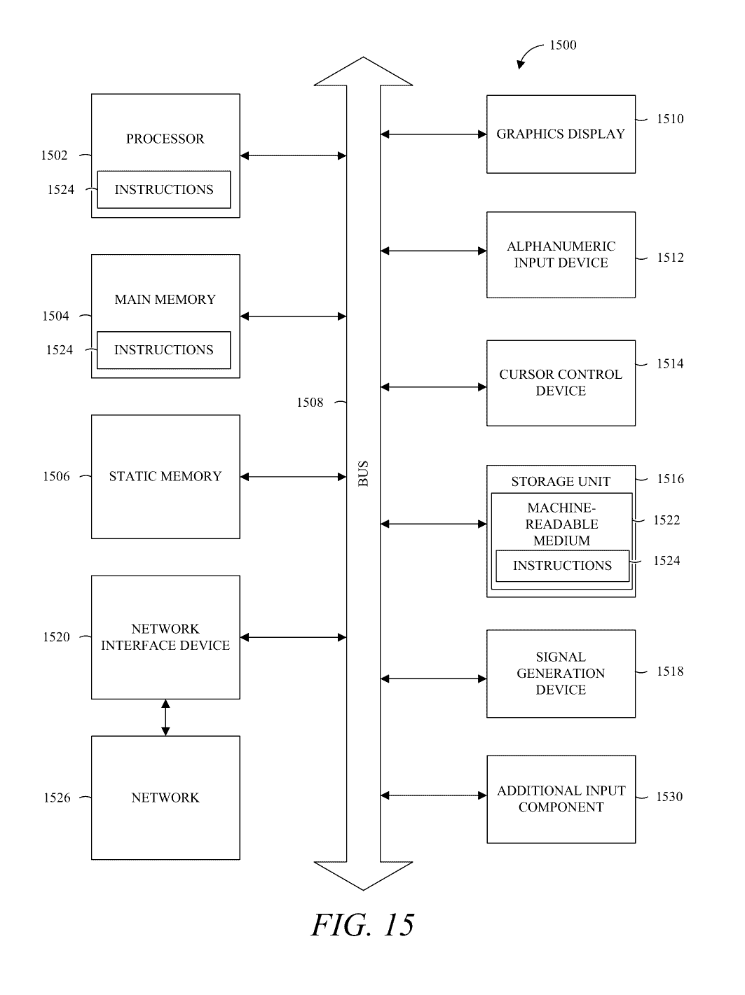

FIG. 15 is a block diagram illustrating components of a machine 1500, according to some example embodiments, able to read instructions 1524 from a machine-readable medium 1522 (e.g., a non-transitory machine-readable medium, a machine-readable storage medium, a computer-readable storage medium, or any suitable combination thereof) and perform any one or more of the methodologies discussed herein, in whole or in part. Specifically, FIG. 15 shows the machine 1500 in the example form of a computer system (e.g., a computer) within which the instructions 1524 (e.g., software, a program, an application, an applet, an app, or other executable code) for causing the machine 1500 to perform any one or more of the methodologies discussed herein may be executed, in whole or in part.

In alternative embodiments, the machine 1500 operates as a standalone device or may be connected (e.g., networked) to other machines. In a networked deployment, the machine 1500 may operate in the capacity of a server machine or a client machine in a server-client network environment, or as a peer machine in a distributed (e.g., peer-to-peer) network environment. The machine 1500 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1524, sequentially or otherwise, that specify actions to be taken by that machine. Further, while only a single machine is illustrated, the term “machine” shall also be taken to include any collection of machines that individually or jointly execute the instructions 1524 to perform all or part of any one or more of the methodologies discussed herein.

The machine 1500 includes a processor 1502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1504, and a static memory 1506, which are configured to communicate with each other via a bus 1508. The processor 1502 may contain microcircuits that are configurable, temporarily or permanently, by some or all of the instructions 1524 such that the processor 1502 is configurable to perform any one or more of the methodologies described herein, in whole or in part. For example, a set of one or more microcircuits of the processor 1502 may be configurable to execute one or more modules (e.g., software modules) described herein.

The machine 1500 may further include a graphics display 1510 (e.g., a plasma display panel (PDP), a light emitting diode (LED) display, a liquid crystal display (LCD), a projector, a cathode ray tube (CRT), or any other display capable of displaying graphics or video). The machine 1500 may also include an alphanumeric input device 1512 (e.g., a keyboard or keypad), a cursor control device 1514 (e.g., a mouse, a touchpad, a trackball, a joystick, a motion sensor, an eye tracking device, or other pointing instrument), a storage unit 1516, an audio generation device 1518 (e.g., a sound card, an amplifier, a speaker, a headphone jack, or any suitable combination thereof), and a network interface device 1520.

The storage unit 1516 includes the machine-readable medium 1522 (e.g., a tangible and non-transitory machine-readable storage medium) on which are stored the instructions 1524 embodying any one or more of the methodologies or functions described herein. The instructions 1524 may also reside, completely or at least partially, within the main memory 1504, within the processor 1502 (e.g., within the processor's cache memory), or both, before or during execution thereof by the machine 1500. Accordingly, the main memory 1504 and the processor 1502 may be considered machine-readable media (e.g., tangible and non-transitory machine-readable media). The instructions 1524 may be transmitted or received over the network 1526 via the network interface device 1520. For example, the network interface device 1520 may communicate the instructions 1524 using any one or more transfer protocols (e.g., hypertext transfer protocol (HTTP)).

In some example embodiments, the machine 1500 may be a portable computing device, such as a smart phone or tablet computer, and have one or more additional input components 1530 (e.g., sensors or gauges). Examples of such input components 1530 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1522 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1524 for execution by the machine 1500, such that the instructions 1524, when executed by one or more processors of the machine 1500 (e.g., processor 1502), cause the machine 1500 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing revenue booking data associated with a customer and identifying a revenue amount booked for delivering an ad product during a campaign delivery period of an advertising campaign associated with the customer;
determining, using a hardware processor, a daily booking value for each date in the advertising campaign delivery period based on the revenue booking data and additional campaign data;
generating a revenue booking graph for the ad product based on the daily booking value for each date in the advertising campaign delivery period; and
causing display of the revenue booking graph for the ad product in a user interface of a device.

2. The method of claim 1, further comprising:
generating a daily delivered revenue value for each past date of the advertising campaign delivery period based on the revenue booking data and historical ad delivery data, the daily delivered revenue value corresponding to one or more instances of the ad product delivered to one or more users as part of the advertising campaign.

3. The method of claim 2, wherein the historical ad delivery data includes a delivered revenue value for one or more instances of the ad product included in the advertising campaign that were actually delivered during an expired time of the delivery period.

4. The method of claim 1, further comprising:
accessing a daily delivered revenue value for each past date of the advertising campaign delivery period, the daily delivered revenue value corresponding to one or more instances of the ad product delivered as part of the advertising campaign;
generating a delivered revenue graph for the ad product based on the daily delivered revenue value for each past date of the advertising campaign delivery period; and
causing display of the delivered revenue graph for the ad product in the user interface of the device.

5. The method of claim 4, wherein the accessing of the daily delivered revenue value includes accessing a plurality of daily delivered revenue values each associated with a plurality of ad products included in the advertising campaign, the plurality of daily delivered revenue values including the daily delivered revenue value; the method further comprising:
aggregating the plurality of daily delivered revenue values, the aggregating resulting in an aggregated daily delivered revenue value,
wherein the generating of the delivered revenue graph for the ad product includes generating a delivered revenue graph for the advertising campaign including the plurality of ad products based on the aggregated daily delivered revenue value, and
wherein the causing of the display of the delivered revenue graph for the ad product includes causing display of the delivered revenue graph for the advertising campaign in the user interface of the device.

6. The method of claim 1, wherein the accessing of the revenue booking data associated with the customer includes accessing a revenue booking value corresponding to an amount booked for delivering a plurality of ad products during a campaign delivery period, the plurality of ad products being included in the advertising campaign,
wherein the generating of the revenue booking graph for the ad product includes generating a revenue booking graph for the advertising campaign including the plurality of ad products based on the revenue booking value corresponding to the amount booked for delivering the plurality of ad products during the campaign delivery period, and
wherein the causing of the display of the revenue booking graph for the ad product includes causing display of the revenue booking graph for the advertising campaign in the user interface of the device.

7. The method of claim 1, further comprising:
generating a forecast daily revenue value for each future date of the advertising campaign delivery period based on a revenue prediction model and historical ad delivery data, the forecast daily revenue value identifying a predicted revenue value for each future date of the advertising campaign delivery period, the forecast daily revenue value corresponding to one or more instances of the ad product forecast to be delivered at a future date as part of the advertising campaign.

8. The method of claim 1, further comprising:
accessing a forecast daily revenue value for each future date of the advertising campaign delivery period, the forecast daily revenue value corresponding to one or more instances of the ad product forecast to be delivered at a future date as part of the advertising campaign;
generating a forecast revenue graph for the ad product based on the forecast daily revenue value for each future date of the advertising campaign delivery period; and
causing display of the forecast revenue graph for the ad product in the user interface of the device.

9. The method of claim 8, wherein the accessing of the forecast daily revenue value includes accessing a plurality of forecast daily revenue values each associated with a plurality of ad products included in the advertising campaign; the method further comprising:
aggregating the plurality of forecast daily revenue values, the aggregating resulting in an aggregated forecast daily revenue value,
wherein the generating of the forecast revenue graph for the ad product includes generating a forecast revenue graph for the advertising campaign including the plurality of ad products based on the aggregated forecast daily revenue value, and
wherein the causing of the display of the forecast revenue graph for the ad product includes causing display of the forecast revenue graph for the advertising campaign in the user interface of the device.

10. A system comprising:
a memory for storing instructions;
a hardware processor, which, when executing instructions, causes the system to perform operations comprising:
accessing revenue booking data associated with a customer and identifying a revenue amount booked for delivering an ad product during a campaign delivery period of an advertising campaign associated with the customer;
determining a daily booking value for each date in the advertising campaign delivery period based on the revenue booking data and additional campaign data;
generating a revenue booking graph for the ad product based on the daily booking value for each date in the advertising campaign delivery period; and
causing display of the revenue booking graph for the ad product in a user interface of a device.

11. The system of claim 10, wherein the operations further comprise:
generating a daily delivered revenue value for each past date of the advertising campaign delivery period based on the revenue booking data and historical ad delivery data, the daily delivered revenue value corresponding to one or more instances of the ad product delivered to one or more users as part of the advertising campaign.

12. The system of claim 11, wherein the historical ad delivery data includes a delivered revenue value for one or more instances of the ad product included in the advertising campaign that were actually delivered during an expired time of the delivery period.

13. The system of claim 10, wherein the operations further comprising:
accessing a daily delivered revenue value for each past date of the advertising campaign delivery period, the daily delivered revenue value corresponding to one or more instances of the ad product delivered as part of the advertising campaign;
generating a delivered revenue graph for the ad product based on the daily delivered revenue value for each past date of the advertising campaign delivery period; and
causing display of the delivered revenue graph for the ad product in the user interface of the device.

14. The system of claim 13, wherein the accessing of the daily delivered revenue value includes accessing a plurality of daily delivered revenue values each associated with a plurality of ad products included in the advertising campaign, the plurality of daily delivered revenue values including the daily delivered revenue value, and wherein the operations further comprise:
aggregating the plurality of daily delivered revenue values, the aggregating resulting in an aggregated daily delivered revenue value,
wherein the generating of the delivered revenue graph for the ad product includes generating a delivered revenue graph for the advertising campaign including the plurality of ad products based on the aggregated daily delivered revenue value, and
wherein the causing of the display of the delivered revenue graph for the ad product includes causing display of the delivered revenue graph for the advertising campaign in the user interface of the device.

15. The system of claim 10, wherein the accessing of the revenue booking data associated with the customer includes accessing a revenue booking value corresponding to an amount booked for delivering a plurality of ad products during a campaign delivery period, the plurality of ad products being included in the advertising campaign,
wherein the generating of the revenue booking graph for the ad product includes generating a revenue booking graph for the advertising campaign including the plurality of ad products based on the revenue booking value corresponding to the amount booked for delivering the plurality of ad products during the campaign delivery period, and
wherein the causing of the display of the revenue booking graph for the ad product includes causing display of the revenue booking graph for the advertising campaign in the user interface of the device.

16. The system of claim 10, wherein the operations further comprise:
generating a forecast daily revenue value for each future date of the advertising campaign delivery period based on a revenue prediction model and historical ad delivery data, the forecast daily revenue value identifying a predicted revenue value for each future date of the advertising campaign delivery period, the forecast daily revenue value corresponding to one or more instances of the ad product forecast to be delivered at a future date as part of the advertising campaign.

17. The system of claim 10, wherein the operations further comprise:
accessing a forecast daily revenue value for each future date of the advertising campaign delivery period, the forecast daily revenue value corresponding to one or more instances of the ad product forecast to be delivered at a future date as part of the advertising campaign;
generating a forecast revenue graph for the ad product based on the forecast daily revenue value for each future date of the advertising campaign delivery period; and
causing display of the forecast revenue graph for the ad product in the user interface of the device.

18. The system of claim 17, wherein the accessing of the forecast daily revenue value includes accessing a plurality of forecast daily revenue values each associated with a plurality of ad products included in the advertising campaign, and wherein the operations further comprise:
aggregating the plurality of forecast daily revenue values, the aggregating resulting in an aggregated forecast daily revenue value,
wherein the generating of the forecast revenue graph for the ad product includes generating a forecast revenue graph for the advertising campaign including the plurality of ad products based on the aggregated forecast daily revenue value, and
wherein the causing of the display of the forecast revenue graph for the ad product includes causing display of the forecast revenue graph for the advertising campaign in the user interface of the device.

19. A non-transitory machine-readable storage medium comprising instructions that, when executed by one or more processors of a machine, cause the machine to perform operations comprising:
accessing revenue booking data associated with a customer and identifying a revenue amount booked for delivering an ad product during a campaign delivery period of an advertising campaign associated with the customer;
determining a daily booking value for each date in the advertising campaign delivery period based on the revenue booking data and additional campaign data;
generating a revenue booking graph for the ad product based on the daily booking value for each date in the advertising campaign delivery period; and
causing display of the revenue booking graph for the ad product in a user interface of a device.

20. The non-transitory machine-readable storage medium, wherein the operations further comprise:
generating a daily delivered revenue value for each past date of the advertising campaign delivery period based on the revenue booking data and historical ad delivery data, the daily delivered revenue value corresponding to one or more instances of the ad product delivered to one or more users as part of the advertising campaign;
generating a delivered revenue graph for the ad product based on the daily delivered revenue value for each past date of the advertising campaign delivery period;
generating a forecast daily revenue value for each future date of the advertising campaign delivery period based on a revenue prediction model and historical ad delivery data, the forecast daily revenue value identifying a predicted revenue value for each future date of the advertising campaign delivery period, the predicted revenue value corresponding to one or more instances of the ad product forecast to be delivered at a future date as part of the advertising campaign;
generating a forecast revenue graph for the ad product based on the forecast daily revenue value for each future date of the advertising campaign delivery period;
causing display of the delivered revenue graph for the ad product in the user interface of the device; and
causing display of the forecast revenue graph for the ad product in the user interface of the device.
